(19) United States
(12) Patent Application Publication
(10) Pub. No.: US 2014/0157515 A1
(43) Pub. Date: Jun. 12, 2014

(54) BED CHAIRS

(71) Applicant: Multifit Hospital Supplies Limited, Whakatane (NZ)

(72) Inventor: Wayne Smeaton Manson, Grafton (NZ)

(73) Assignee: MULTIFIT HOSPITAL SUPPLIES LIMITED, WHAKATANE (NZ)

(21) Appl. No.: 14/039,474

(22) Filed: Sep. 27, 2013

(30) Foreign Application Priority Data
Sep. 27, 2012 (NZ) 602699

(51) Int. Cl. A47C 17/16; A61G 5/00

(52) U.S. Cl. CPC A47C 17/162; A61G 5/006
USPC 5/13

(57) ABSTRACT

A bed chair apparatus includes a user support surface which includes a seat section, a back section, and a leg section, the back section being hingedly connected to one end of the seat section, and the leg section being hingedly connected to the other end of the seat section. The user support surface is configurable in a bed configuration in which the support surface is substantially flat and in a chair configuration, the user support surface being supported on a frame, the frame including an axle and lever dependent from the axle. The lever controls articulation of the user support surface between selected configurations upon rotation of the axle.

### FIELD OF THE INVENTION

This invention relates to a piece of resting furniture and has particular relevance to a bed which is convertible to a chair or chair-like configuration.

### BACKGROUND

Many people, particularly disabled people, find it difficult getting in and out of bed. The reasons for this are many but include:

a) general muscle weakness because of age, sickness, disease, low mental ability or balance; and

b) inability or difficulty of movement because of surgery, hip replacement or back injury.

Caregivers for this type of patient also have problems with caring for the patient. Among their concerns are manual handling injury caused by helping the patient in and out of bed and back injuries from having to stoop over a low bed when tending to a patient. Surface shear on the patient skin as the patient is being transferred on and off the bed, or as the mattress profiles under the body of the patient, can also be an issue.

Existing solutions include:

1. Powered Leg Lifters

These work with some people but many people cannot use them because:

a) they lack the required muscle strength to balance on the bed as their feet are being raised;

b) they cannot use the handset controller that is typically required for use of the product;

c) they do not have the ability to move their feet off the leg lifter foot rest and onto the bed; and

d) they do not like the appearance of the leg lifter beside their bed.

2. Chair Beds

These are basically recliner chairs with a mattress topper pad for extra comfort. Some chair beds have additional width to simulate a bed and some are made with customized seat depth and height to suit the user's posture and stature.

Chair beds work with some people but many people cannot use them because:

a) the mattress platform does not lay completely flat and therefore they are not able to roll onto their sides for comfort while sleeping;

b) the mattress platform is always too short. This is because the seat height determines the length of the leg rest. When the leg rest raises to the horizontal position their feet are left hanging over the end of the leg rest and are therefore unsupported;

c) the chair bed looks like a chair and not a bed and therefore can be rejected as a bedroom item; and

d) the chair bed is a fixed height and is therefore at a very low position for care giving tasks.

3. Bed Chairs

These typically provide a full bed which is convertible into a chair-like form. The disadvantages include:

a) poor ergonomic design which make them very uncomfortable to sit in and use;

b) the motors are slow and work independently which means users have to know which button to push and for how long in order to get the sit to lie action working properly;

c) they are very heavy to transport; and

d) some try to solve the problem of the feet hanging over the end of the mattress by providing a foot plate which rises with the leg rest and prevents a user's feet coming off the end of the mattress, but the result is that the patient's body is either pushed up into the mattress or their legs become bent. When in the lie flat position their feet also end up being pushed hard against the foot rest which can be cold and uncomfortable.

4. Inflatable Chairs:

a) these are designed to hoist a person into and therefore do not support independent transfer on and off the bed;

b) they do not lie completely flat; and

c) feet are typically left unsupported when in the horizontal position.

Known Bed Chair solutions also suffer from being expensive to manufacture, and thus expensive to purchase.

The reference to any prior art in the specification is not, and should not be taken as, an acknowledgement or any form of suggestion that the prior art forms part of the common general knowledge in any country.

### OBJECT

It is an object of the present invention to provide a resting apparatus such as a bed or bed chair which will overcome one or more of the foregoing disadvantages. Alternatively, it is an object of the present invention to at least provide the public with a useful choice.

### SUMMARY

A bed chair apparatus including a user support surface which includes a seat section a back section and a leg section, the back section being hingedly connected to one end of the seat section, and the leg section being hingedly connected to the other end of the seat section, whereby the user support surface is configurable in a bed configuration in which the support surface is substantially flat and in a chair configuration, the user support surface being supported on a frame, the frame including an axle and lever means dependent from the axle whereby the lever means control articulation of the user support surface between selected configurations upon rotation of the axle.

Preferably a single actuator means is operable to cause rotation of the axle.

Preferably the support surface extends along a longitudinal axis of the apparatus and the axle extends transversely relative to the longitudinal axis.

Preferably the axle is provided between the frame and the support surface at a location along the longitudinal axis which is at or adjacent to the hinge connection between the seat section and the back section.

Preferably the axle is provided nearer to the frame than the base. Preferably the axle is mounted as very near to the seat section.

Preferably the seat section changes angle relative to the frame during articulation.

Preferably the support surface further includes a foot section hingedly connected to the leg section.

Preferably the foot section is linked to a rocker lever mounted beneath the leg section.

Preferably the rocker lever is pivotally connected to the leg section.

Preferably the rocker lever is linked to a drive lever dependent from the axle.

Preferably when the apparatus is in a bed configuration a connection between the drive lever and the link is in an over centre position.

Preferably a part of the drive lever bears against a part of the frame when in the over centre position.

Preferably, when in the over centre position, the leg section is prevented from articulating to the chair configuration.

Preferably a further axle is provided which is rotatable relative to the axle to further articulate the apparatus.

Preferably the frame is modular and is adapted to be individually selectively mounted on one of a plurality of different bases.

Preferably the actuator is mounted on or includes a shock absorber.

Preferably when in a bed configuration the hinged connections between the sections of the support surface are substantially aligned and located nearer to an upper surface of the mattress than a lower surface.

Preferably the hinged connections are located near or at the top (i.e. the surface on which a user normally rests) of the mattress.

According to another aspect the invention provides a bed chair apparatus which is selectively configurable between a chair configuration and a bed configuration, and which includes a mattress having a cavity for a flowable substance and means to introduce, expel or change the position or location of the flowable substance dependent on the articulation of the apparatus.

In one embodiment the flowable substance comprises a fluid. In another embodiment the flowable substance comprises particulate matter.

According to another aspect of the present invention there is provided a bed chair apparatus including a user support surface which includes a plurality of sections that are configured to articulate relative to each other, whereby the user support surface is configurable in a bed configuration in which the support surface is substantially flat and in a chair configuration, the user support surface being supported on a frame, the frame including an axle and lever means dependent from the axle whereby the lever means control articulation of the user support surface between selected configurations upon rotation of the axle.

In one embodiment the axle is rotated manually. In another embodiment the axle is rotated using an actuator. In one embodiment a single actuator is used. In another embodiment a plurality of actuators are used.

Preferably the sections are articulated simultaneously using one actuator.

Preferably the axle is rotated by a lever. In one embodiment the lever comprises a handle. In another embodiment the lever is driven by an actuator such as a linear actuator.

Preferably the support surface comprises a back section, a seat section, a lower leg section and a foot section. In one embodiment the support surface further comprises a toe section.

Preferably a leg control lever is dependent from the axle for controlling articulation of the lower leg section. In one embodiment there is a link pivotally connected between the leg control lever and the lower leg section.

Preferably the leg control lever also controls articulation of the foot section. In one embodiment there is a plurality of links pivotally connected between the leg control lever and the foot section.

Preferably there is at least one link pivotally connected to the leg lever whereby when the support surface is in the bed configuration the pivot connection is in an over centre position.

Preferably the pivot connection when in the over centre position is constrained by a stop means.

Preferably the stop means comprises a part of the seat section.

Preferably a seat control lever is dependent from the axle for controlling articulation of the seat section.

Preferably a back rest control lever is dependent from the axle for controlling articulation of the back rest section.

In one embodiment the back rest control lever is connected to the axle so as to rotate therewith.

In another embodiment the back rest control lever can rotate relative to the axle. Preferably the seat control lever includes a back rest stop means to further control movement of the back rest control lever.

Preferably the back rest stop means is adjustable.

In one embodiment the stop means is manually adjustable. In another embodiment the back rest stop means is adjustable using an actuator.

Preferably the control means comprises a stop or bar.

Preferably articulation of the back portion may occur separately from articulation of the remainder of the support surface.

Preferably, when in the chair configuration, the foot section is disposed beneath the seat section.

Preferably the bed chair apparatus comprises a means to separately adjust the height of the support surface relative to a floor surface or base frame.

Preferably a support means is provided to prevent overbalancing of the apparatus when in a bed configuration.

Preferably the support means is moveable longitudinally relative to the frame.

Preferably the bed chair apparatus is adapted to be moved between the bed configuration and the chair configuration by a single actuation means.

Preferably the bed chair apparatus comprises a foot section link member between the leg section and the foot section.

Preferably the bed chair apparatus comprises a back section link member between the axle and the back section.

Preferably the support surface comprises a mattress which is provided on a frame, the frame having pivotal connections between adjacent sections of the support surface to enable the sections to articulate relative to each other.

Preferably the pivotal connections between sections of the support surface are closer to an upper surface of the mattress than to a lower surface of the mattress.

Alternatively the support surface comprises support formations for receiving a mattress or for receiving individual mattress sections.

According to a second aspect of the invention there is provided a bed chair apparatus including a user support surface configurable in a bed configuration in which the support surface is substantially flat and in a chair configuration, the support surface being pivotally connected to a support frame, a base frame being provided for resting on a ground or floor surface, and height adjustment means for varying the height of the support frame relative to the base frame to thereby adjust the height of the support surface.

Preferably the height adjustment means includes a one or more arms pivotally connected between the support frame and the base frame whereby rotation of the one or more arms about the pivot connection varies the height of the support frame relative to the base frame.

In one embodiment the height adjustment means includes an actuator.

In another embodiment the apparatus includes two arms pivotally mounted between the base frame and the support frame and an actuator means whereby the actuator means rotates one or both arms to thereby varying the distance between the base frame and the support frame. In one embodiment the actuator means is pivotally connected to a bell crank which is arranged to move one or both arms.

According to a third aspect of the invention there is provided a bed chair apparatus including a user support surface configurable in a bed configuration in which the support surface is substantially flat and in a chair configuration, the support surface being pivotally connected to a support frame, a base frame being provided for resting on a ground or floor surface, and a swivel means between the base frame and the support frame to allow the support frame to rotate about at least a substantially vertical axis of movement relative to the base frame.

According to a fourth aspect of the present invention there is provided a bed chair apparatus according to any one of the preceding aspects which may swivel about a vertical axis of rotation.

According to a fifth aspect of the invention there is provided a bed chair apparatus according to any one of the preceding aspects which further includes or functions as a commode.

According to a further aspect of the present invention there is provided a bed chair of all the preceding aspects.

According to a further aspect of the present invention there is provided a bed chair substantially as herein described with reference to any one or more of the accompanying examples and/or figures.

In another aspect the invention provides any new feature or new combination of features described herein.

Further aspects of the invention, which should be considered in all its novel aspects, will become apparent from the following description given by way of example of possible embodiments of the invention.

### DRAWING DESCRIPTION

Embodiments of the invention will be described below with reference to the accompanying drawings, in which:

FIGS. 2 to 6: are side elevations of a first embodiment of a bedchair in accordance with the invention showing various folding configurations of the bed chair from an initial sitting-eject configuration to a flat bed configuration;

FIG. 7: is a perspective view of the apparatus of FIG. 1 in the bed configuration;

FIGS. 7c-7e: are simplified side elevating showing articulation more clearly;

FIGS. 10 and 11: are perspective views of part of an actuation mechanism for a further embodiment including an actuator;

FIGS. 12 and 13: are perspective views of part of an actuation mechanism for a further embodiment including two actuators;

FIGS. 15 to 19: are side elevations of another embodiment showing various folding configurations of the bed chair from an initial sitting-eject configuration to a flat bed configuration;

FIG. 20: is a perspective view of the apparatus of FIG. 14 in the bed configuration;

FIG. 21: is a perspective view of another embodiment of the invention in a raised bed configuration;

FIGS. 22 to 27: are side elevations of the embodiment of FIG. 21 showing various folding configurations of the bed chair from a raised flat bed configuration through to a sitting-eject configuration;

FIG. 28: is an exploded perspective view of the embodiment of FIG. 21 excluding hand rails in a lowered bed configuration;

FIGS. 30 to 33: are side elevations of the embodiment of FIG. 29 showing various folding configurations of the bed chair from an initial sitting-eject configuration to a flat bed configuration;

FIG. 34: is a side elevation of the bed chair apparatus shown in FIGS. 29 to 33, shown in a raised bed configuration;

FIG. 35: is a perspective view of the bed chair, and configuration, depicted in FIG. 34;

FIG. 36: is a perspective view from below of a further embodiment of an articulation mechanism for bed chair apparatus according to the invention;

FIG. 37: is a side elevation of the apparatus of FIG. 36;

FIGS. 39 to 42: are side elevations of the embodiment of FIG. 38 showing various folding configurations of the bed chair from an initial sitting-eject configuration to a flat bed configuration;

FIG. 43: is a side elevation of the bed chair apparatus shown in FIGS. 38 to 42, shown in a raised bed configuration;

FIG. 44: is a perspective view of the bed chair, and configuration, depicted in FIG. 43;

FIGS. 46 to 49: are side elevations of another embodiment showing various folding configurations of the bed chair from an initial sitting-eject configuration to a flat bed configuration;

FIG. 50: is a side elevation of the bed chair apparatus shown in FIGS. 46 to 49, shown in a raised bed configuration;

FIG. 51A-51C: are perspective views of the bed chair, and configuration, depicted in FIG. 50;

FIGS. 52A and 52B: are side elevations showing movement of links more clearly between the raised and lowered positions for the embodiment of FIGS. 53-56.

FIGS. 53 to 55: are side elevations of the embodiment of another embodiment showing various folding configurations of the bed chair from a chair configuration to a flat bed configuration;

FIG. 56: is a perspective view of the bed chair, and configuration, depicted in FIG. 55;

FIG. 59: is a diagrammatic front elevation showing the bed chair apparatus of FIG. 52 in a flat configuration next to a bed;

FIGS. 60 and 61: [[is a]] are diagrammatic front elevations of the bed chair apparatus of FIG. 52 in a flat configuration, but including a modification to assist transfer of a user of the apparatus from the apparatus to a bed;

FIG. 63: is a side elevation of a further embodiment;

FIGS. 65 to 68: show partial views of an alternative actuator and linkage arrangement for use with the invention;

FIGS. 77 to 79: show another embodiment which includes a sliding frame section which may be used with any one of the preceding embodiments.

FIGS. 80 to 83: show various views of a further embodiment of a bed chair apparatus which may be lowered to floor level.

FIG. 84: shows an actuator mounting arrangement

FIG. 85a: shows an embodiment which offers an alternative arrangement for preventing entrapment of an object below the leg rest section.

FIG. 85b: shows a base member which may be used with a modular detachable frame, such as the frame module shown in FIG. 85a.

FIGS. 86 and 87: show partial isometric views of an additional tilt or articulation mechanism.

FIG. 88: shows a swivel base frame module is shown which is easily attachable at to the middle frame module shown in FIG. 85a.

FIGS. 89 and 90: show an adjustable height base frame module which is easily attachable to the middle frame module shown in FIG. 85a.

FIG. 91: shows an embodiment having an adjustable height base frame module with a swivel attachment frame.

FIG. 92: shows an adjustable height base frame module with telescopic mobile base.

FIG. 93: shows an adjustable height base frame module with scissor action base with the actuator mounted vertically at one end.

FIG. 94: shows a side view of the mattress showing the hinge points in alignment.

FIG. 95: is a cross section through the foot section of the mattress at A-A on FIG. 94.

FIG. 96: is a cross section though the seat section of the mattress at B-B on FIG. 94.

FIGS. 97-99: show articulation of another embodiment in side elevation.

FIGS. 100-111: show partial elevations of components during stages of articulation of the embodiment shown in FIGS. 97-99.

### DETAILED DESCRIPTION OF THE DRAWINGS

FIGS. 2-7E show a first embodiment of a bed chair apparatus. The apparatus includes a longitudinally disposed user support surface consisting of a back rest portion 23, seat portion 20, upper leg portion 21 and lower leg or foot portion 22. In some embodiments the foot section may not be provided. These portions of the support surface are arranged to articulate relative to each other to allow the apparatus to adopt desired configurations or profiles from a substantially flat bed configuration to a chair-like configuration. Thus the sections are hingedly directly connected to each other by hinges 36, 68 and 70.

FIG. 2 is a side elevation in the sitting-eject configuration which is the same configuration as shown in the perspective view of the apparatus in FIG. 1. In the sitting-eject configuration shown in FIGS. 1 and 2 the apparatus is configured or profiled to allow a user to transfer from the apparatus, e.g. to move to a standing position or to allow an assistant such as a caregiver to move the user from the apparatus to another apparatus e.g. a wheelchair or vehicle. Similarly, the sitting-eject configuration may be used to facilitate the introduction of a user to the apparatus e.g. to allow a user to move easily from a standing position adjacent to the apparatus to an initial seated position in which the user is properly seated with his or her lower back against the base of the back-rest portion 23 of the apparatus.

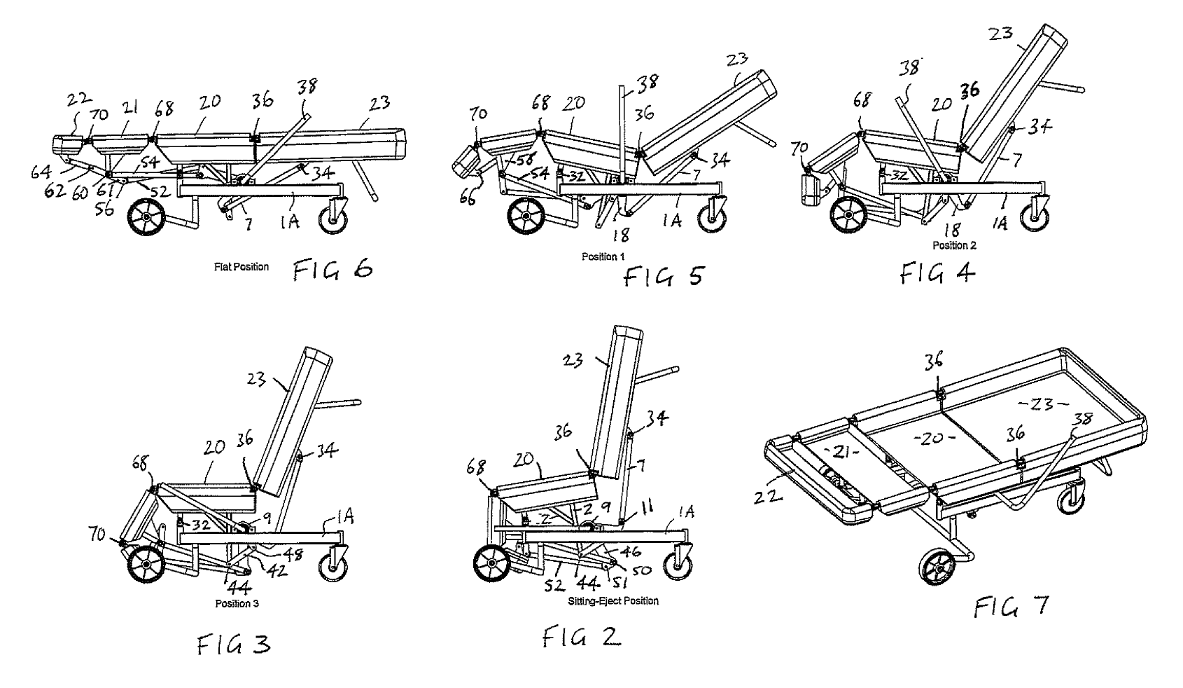

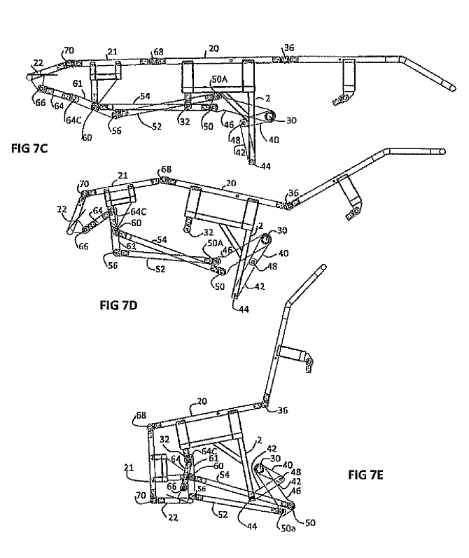

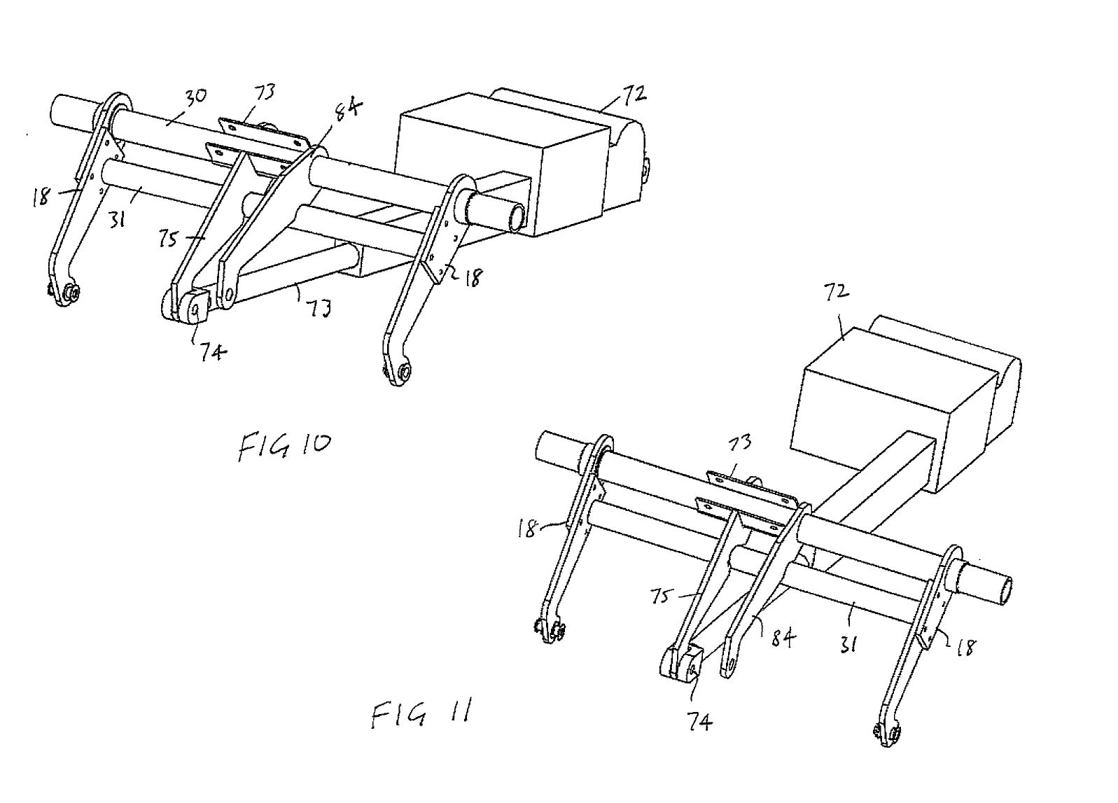

FIG. 3 shows the apparatus in a chair position in which the foot section is folded under the seat section for the user to sit comfortably. FIGS. 4 and 5 show transitional configurations as the apparatus is reconfigured or profiled into the flat bed configuration shown in FIG. 6 (side elevation) and FIG. 7 (perspective view).

Still referring to FIGS. 2-7E, the apparatus has a base frame generally referenced 1 which includes two longitudinal frame members 1A, and a cross-member 1B spanning the two longitudinal members 1A. Bearings 9 are mounted on members 1A of the frame and support an axle assembly 30, the operation of which will be described further below. Near the front end of the frame assembly, pivot joints 32 connect each side of the front part of seat portion 20 to the frame members 1A.

Struts 2 are connected to the central-rear part of each side of the seat portion 20 and these are pivotally connected to links 42 by pivot connections 44. Links 42 are in turn connected to lever arms 40 by pivot connections 48. As with all the pivot connections described herein, appropriate bushes or other bearing surfaces or arrangements can be used if necessary to ensure the pivotal connections operate effectively. Lever arms 40 are fixedly connected to transverse axle 30 so as to turn therewith.

Axle 30 is connected to axle extension 25 which is in turn connected to, or a part of, lever handle 38. Angular movement of lever 38 in a plane perpendicular to the axis or rotation on axle 30 rotates axle 30. As axle 30 is rotated, levers 40 articulate the central-rear part of seat portion 20 relative to the front of the seat portion about pivot connection 32. As handle 38 is moved upwardly from the position shown in FIG. 2, the axle 30 is rotated clockwise (when viewed as shown in FIGS. 2-6), so that the process or articulation occurs as shown sequentially in the Figures.

In one embodiment, lever arms 18 are pivotally mounted on axle 30, and lever arms 18 are interconnected by crossbar 31 and are also pivotally connected to tie rods 7 by pins 8 and 11. In practice the crossbar 31 and distal ends of the arms may be formed as one component then screwed and riveted to stubs provided on axle 30 to form the assembly shown. Tie rods 7 are in turn connected to the back rest 23 by pivot connections 34. Back rest 23 is pivotally connected to seat portion 20 by pivot connections 36. So in this embodiment back rest 23 is unsupported except by virtue of crossbar 31 resting or floating on lever arms 40 which occurs under the influence of gravity. Thus as the seat portion articulates under control of lever arms 40, so too does the back rest portion 23. In another embodiment lever arms 18 are fixedly connected to cable 30 so as to rotate therewith.

A handlebar 3 is connected to the rear of the back rest 23 to facilitate movement of the apparatus which in this embodiment has castor wheels 19 mounted at rear ends of the frame and wheels 24 mounted on axles 26 dependent from the front end of the frame.

Articulation of the leg and foot rest portions 21 and 22 is controlled by lever arms 46 which are also fixedly connected to the axle 30. The distal end of each lever arm 46 includes pivot connections 50 and 51 which connect to links 54 and 52 respectively. The distal end of link 54 is connected at pivot connection 60 to web 58 which depends from leg rest 21. Pivot connection 60 is also pivotally connected to link 61 which is in turn connected to link 52 at pivot connection 56. The other end of link 61 is pivotally connected to link 64 at pivot connection 62, and link 64 is pivotally connected to the foot section 22 at pivot connection 66. Thus as the axle 30 rotates under control of handle 38, the leg and foot rest sections articulate simultaneously with the seat and backrest sections as shown in FIGS. 2-6. The seat section can be seen to change in angle relative to the frame or base.

Those skilled in the art will appreciate that the articulation mechanism comprising links and levers 61 and 64 may in effect be repeated so that a further articulation section may be pivotally added to the distal end of the footrest, so that a “toe rest” portion can be added to the overall support surface.

Referring now to FIGS. 7C-7E, further explanation of articulation of the apparatus is now described.

Mattress Articulation

The mattress frame, also referred to in this document as providing the basis for a support surface connects to and pivots about the sub or base frame at points 30 and 32

The back rest levers, drive levers and actuators are omitted for clarity.

Seat Section Articulation

Action

The seat section 20 tilts forward when in the chair position, rearward when in the reclined position and is horizontal when in the bed position.

The seat tilt is synchronised with the back 23, leg 21, foot 22, rests by means of their common connection through the drive axle 30

Connections

Lever 40 rotates about axle 30 and is pivotally connected at 48 to link 42 which is pivotally connected to seat leg 2 at point 44.

Method

As lever 40 rotates the above connections cause the seat section 20 to tilt forward and rearward about the pivot point 32.

Leg Rest Section Articulation

Action

The leg rest 21 is approximately in line with the seat rest section 20 when the mattress or support frame is in the bed position.

The leg rest section 22 folds downward at approximately 90 degrees to the seat rest section 20 when in the chair position.

Connections

Lever 46 rotates about drive axle 30 and is pivotally connected to link arm 54 at point 50 and at point 60 to the leg rest section 21 which is pivotally connected to the seat rest section 20 at point 68.

Method

As lever 46 rotates, it pushes the link arm 54 which in turn articulates the leg rest section 21 in relation to the seat rest section 20.

Foot Rest Section Articulation

Action

The foot rest section 22 is approximately in line with the leg rest section 21 when the mattress is in the bed position.

The foot rest section 22 has rotated downward approximately 180 degrees when in the chair position and is folded under the seat rest section 20 and facing rearwardly.

Connections

Lever 46 rotates about drive axle 30 and is pivotally connected to link arm 52 at point 50a and to see-saw link 61 at point 56.

See-saw link 61 pivots about point 60 and connects pivotally to link bar 64 at point 64c

Link bar 64 connects pivotally to foot rest 22 at point 66.

The foot rest connects pivotally to the leg rest at point 70

Method

As lever 46 rotates, it pushes link bar 54 outward causing leg rest section 21 and see-saw link 61 to rotate about point 68.

As lever 46 continues to rotate it causes link bar 52 to pull on the see-saw link 61 at point 56 causing the see-saw link 61 to rotate about point 60, pushing link bar 64 forward at point 64c. Link bar 64 causes the foot rest section 22 to rotate at point 70 in relation to the leg rest section 21.

The range of movement created by the separation of points 50a and 50 on lever 46 is used to rotate the see-saw link which folds/unfolds the foot rest section 22.

It will be seen that the articulation arrangement described allows the whole support surface (i.e. the whole mattress) to be supported by axle 30 and the front portion 32 of seat section 20.

It will be seen that, when articulating from the configuration shown in FIG. 5 to that shown in FIG. 6, lever arm 46 moves to an overcentre position relative to links 52 and 54. Therefore, in the configuration shown in FIG. 6, a downward force applied to the foot section 22 (in response, for example, to a person sitting on the foot section) will assist in maintaining the apparatus in the existing (i.e. bed) orientation (as opposed to facilitating transition of the apparatus toward the chair orientation). The lever arm 46 “bottoms out” against the underside of seat portion 20, so additional weight is supported by the stop on the underside of the seat without collapse. Over 220 kg can be placed on the end of the bed in some embodiments. The effect is the same when load is placed on the end of the backrest. Also, all other arms that are fixedly connected to axle 30 will also be located in position which further increases rigidity and stability of the assembly.

Turning now to FIGS. 10 and 11, an actuation mechanism is shown which includes an actuator 72 for the axle arrangement described above so that the articulation of the back rest portion 23 can be controlled independently over at least part of the articulation sequence if desired. The actuator may be driven electrically for example, and has an arm 73 that extends and retracts relative to the body of the actuator. A pivot connection 74 connects arm 73 to lever arm 75 which is connected to crossbar 31 by bracket 76 which allows arm 75 to pivot about axle 30. Thus as the actuator arm 73 is extended and retracted, it moves bar 31 so lever arms 18 are rotated back and forth in order to control articulation of the back rest independently of levers 40.

Lever arm 75 can simply float as one option, or be disconnected if desired.

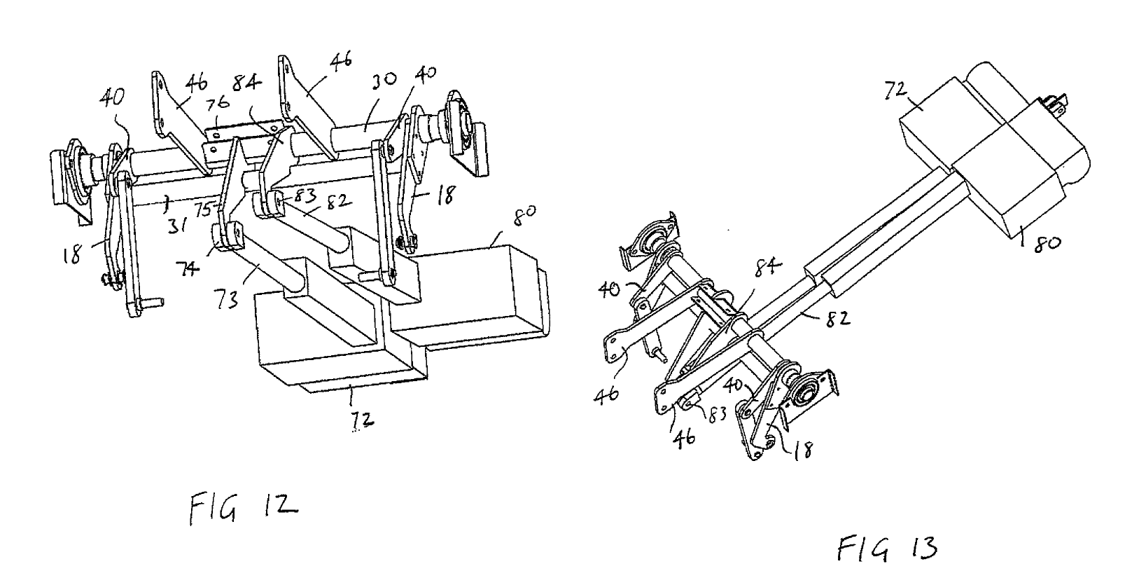

In FIGS. 12 and 13 the arrangement of FIGS. 10 and 11 is further expanded upon with another actuator 80 which controls rotation of axle 30. Actuator 80 has an extendable arm 82 which is connected at pivot connection 83 to a lever arm 84 that is affixed to axle 30.

FIGS. 15-20 show another embodiment of the bed chair apparatus which includes the actuation mechanism shown in FIGS. 12 and 13. The remaining features are the same as described with reference to the embodiment of FIGS. 2-7 with some exceptions. The frame has been altered to accommodate the actuators 72 and 80, and the handle 38 is no longer present as it is not required. In the embodiment of FIGS. 2-7 the frame that carried the user support portions was hidden but in the drawings for this embodiment it is now shown. It will be appreciated that the frame as shown in FIGS. 15-20 may be incorporated into a mattress structure to provide the user support surface, or an arrangement as shown in the embodiment of FIGS. 2-7 may be used in which the frame has formed carrying portions which support an entire mattress or individual mattress parts in order to provide the user support surface. The formed carrying portions shown in the embodiment of FIGS. 2-7 may be created in a number of different ways. In one example they may be moulded from plastic.

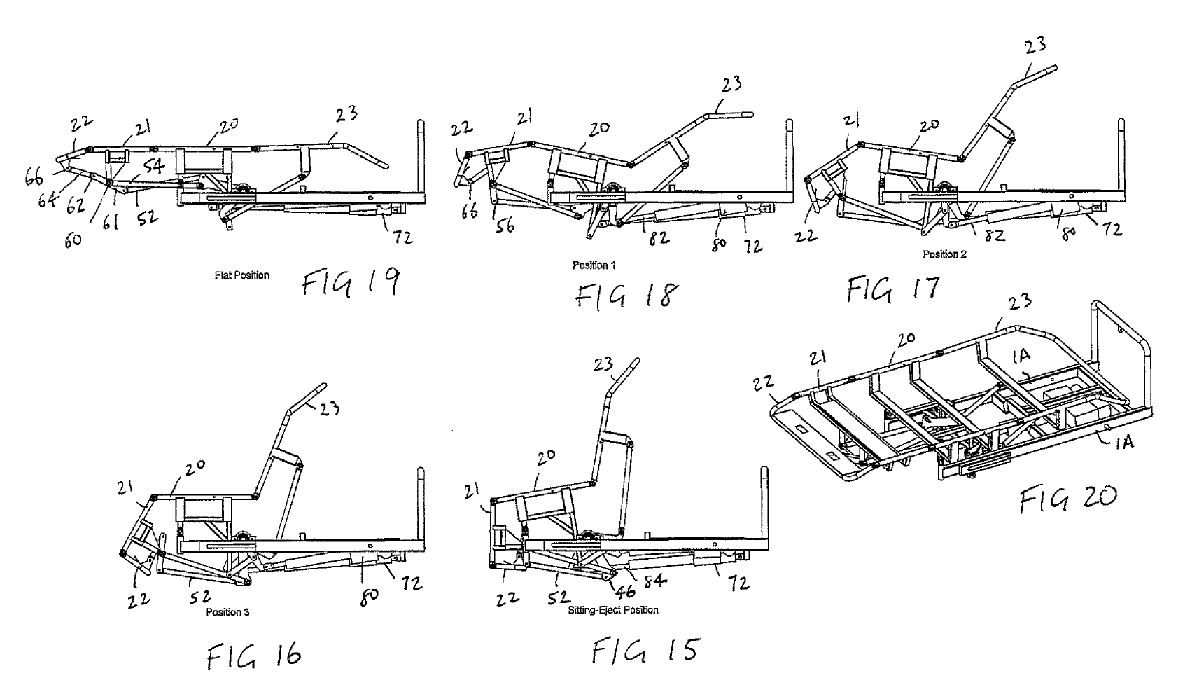

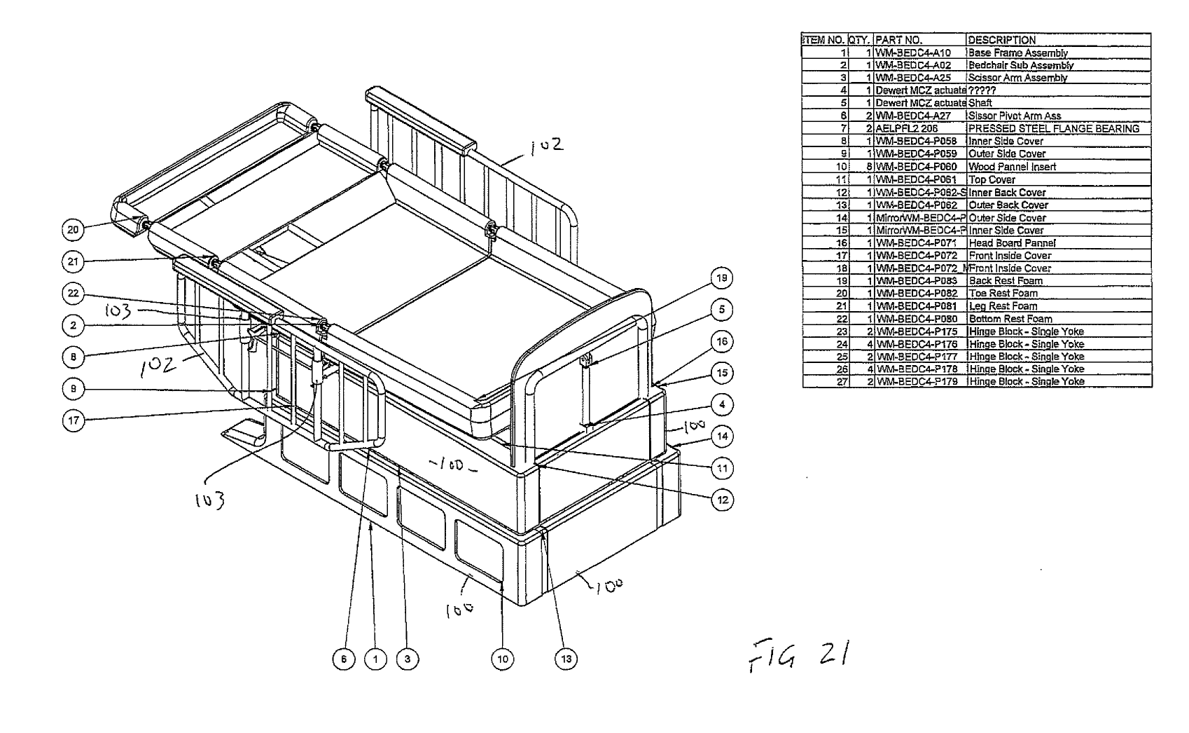

FIG. 15 shows a side elevation of the new embodiment. FIG. 16 shows the apparatus in a chair position for the user to sit comfortably. FIGS. 17 and 18 show transitional configurations as the apparatus is reconfigured or profiled into the flat bed configuration shown in FIG. 19 (side elevation) and FIG. 20 (perspective view).

The construction shown in the embodiment of FIGS. 15-20 may be combined with other base frame structures dependent upon the application required, as will now be described with reference to further embodiments below.

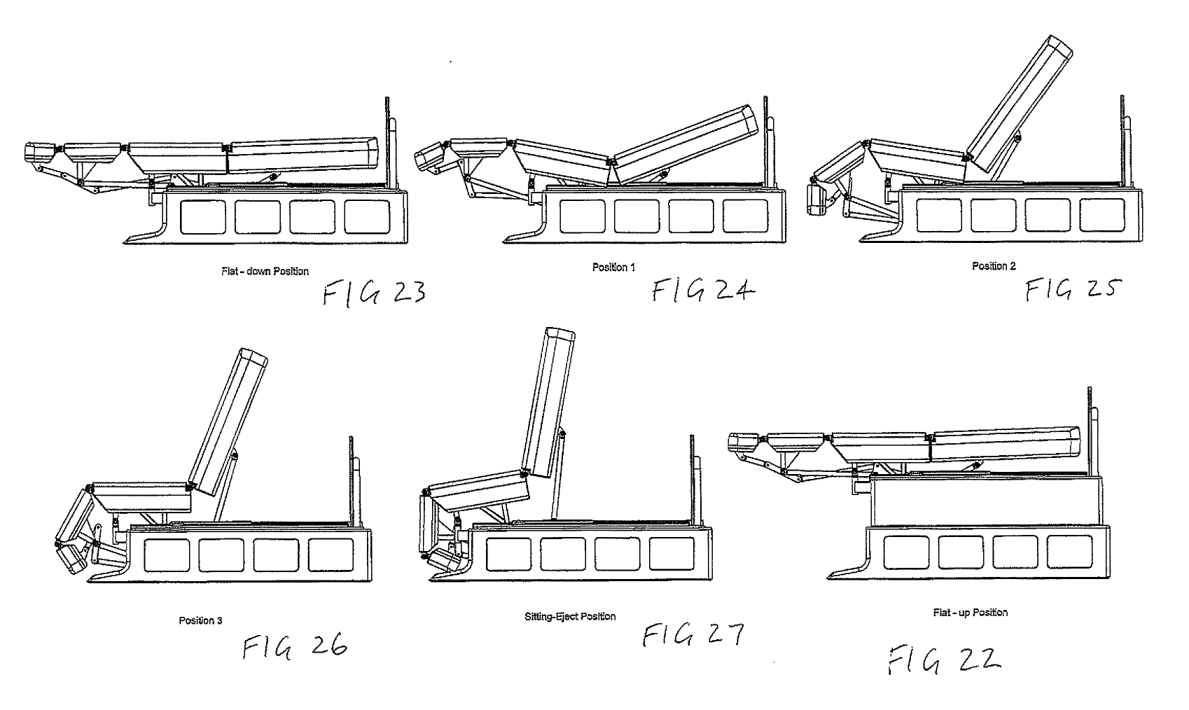

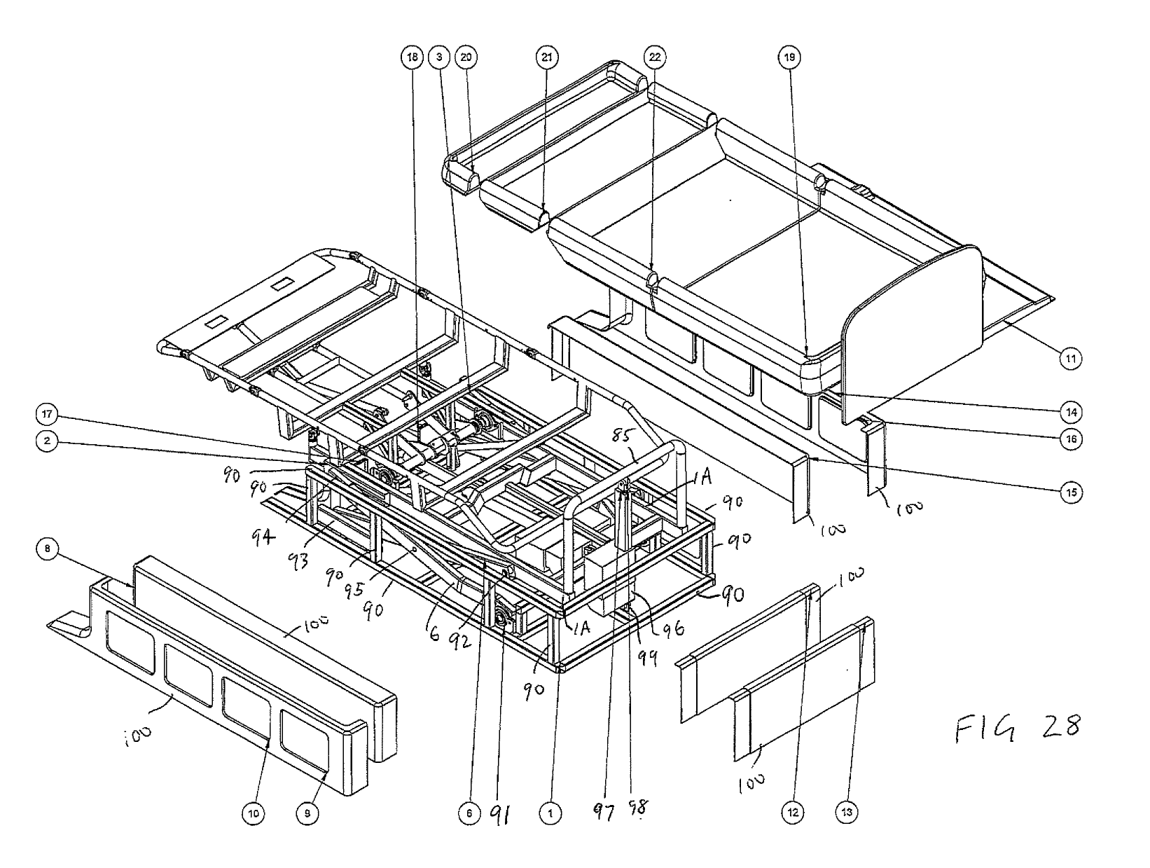

Turning now to FIGS. 21 to 28, a further embodiment is shown. Reference numerals used in relation to the embodiments described above denote the same or similar features in the description relating to this embodiment. The support frame including frame members 1A supports the same operating mechanism as described in the embodiment of FIGS. 15-20. The support surface is also the same as described in both the embodiments of FIGS. 15-20 and FIGS. 2-7.

A new feature in the embodiment shown in FIGS. 21 to 28 is that a base frame comprising frame members 90 which support a lifting mechanism which is in turn connected to the support frame members 1A and support frame end member 85. The lifting mechanism includes scissor arms 6 which are pivotally mounted between the side base frame members 90 and support frame members 1A at pivot connections 91 and 92 and slideably pivotally connected via slide arms 93 and 94. Scissor arms 6 are pivotally connected to each other at pivot connection 95.

An actuator 96 has an extendable arm 97 and is connected at connection 98 to arm 85 of the support frame, and at connection 99 to the base frame. Thus the actuator 96 can be used to raise or lower the support frame relative to the base frame. The apparatus is shown in the elevated position in FIGS. 21 and 22, and in the lowered position in FIGS. 23-28. The articulation between configurations is shown in FIGS. 23-27 and it will be appreciated that the apparatus can be elevated if required in any of these intermediate configurations. Appropriate cosmetic/safety cover sections 100 are also provided if required. Other cover arrangements can be used.

FIG. 21 also shows the use of handrails 102 which mounted slideably relative to the support frame at connection points 103 to allow one or both handrails to be selectively lowered to facilitate a user or caregiver having access to the support surface.

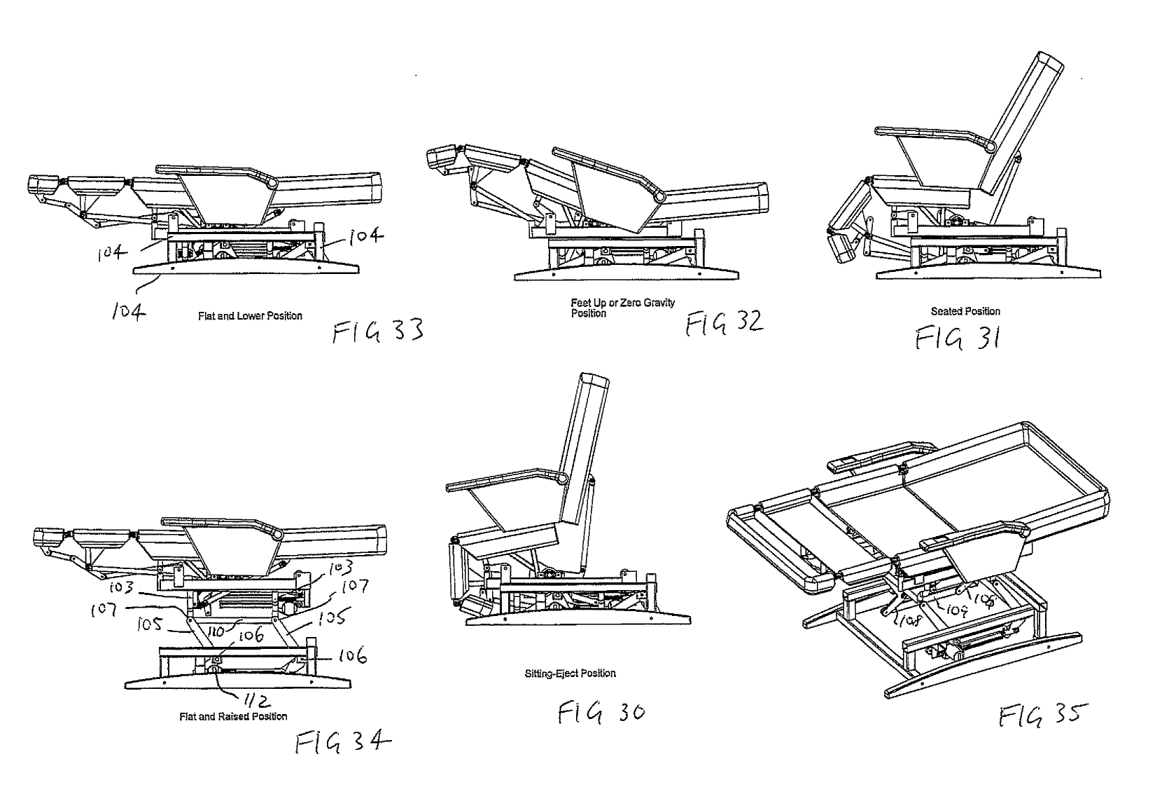

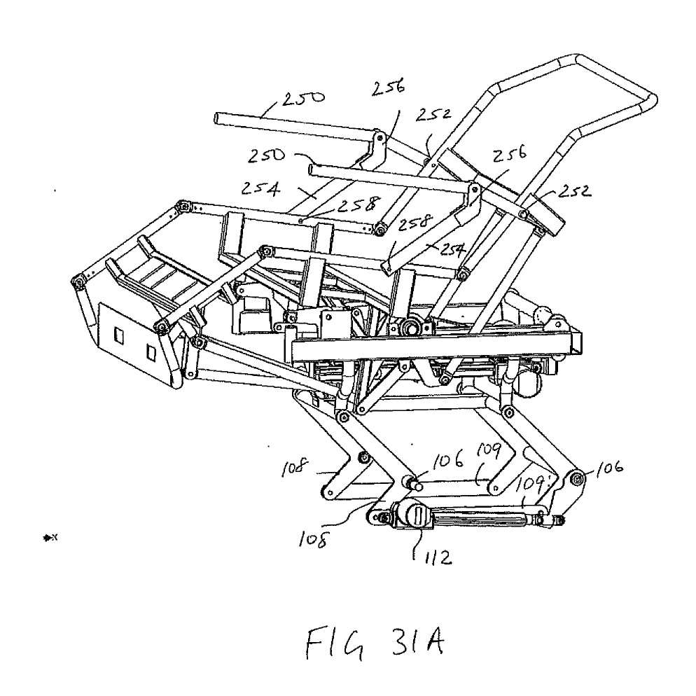

In FIGS. 30-35 another embodiment is shown. This embodiment has a base frame comprising members 104. The support frame which includes members 1A includes legs 103 which end in a spacer bar 110 and to which lever arms 105 are pivotally connected at pivot connections 107. Levers 105 include a distal end 108 forming an elbow at which a pivot connection 106 to the base frame is provided. A link bar 109 is pivotally connected between the ends 108, and an actuator 112 is connected between the base frame and pivot 106 to thereby raise or lower the support frame relative to the base frame. Detail of the arrangement is shown in FIG. 31A.

FIG. 31A also shows an embodiment of an articulating arm rest which may also be used in conjunction with the other bed chair embodiments described herein. The arm rest bars are pivotally connected to the backrest portion at pivot connections 252. Armrest links 254 have an elbow 256 at the upper end which is connected pivotally at 258 to each bar 250. Links 254 are pivotally connected at the other end by pivot connection 258 to the seat portion. Thus, the arm rest bars 250 articulate so that they are raised in the chair position and lowered in the bed position, as shown in FIGS. 32-35.

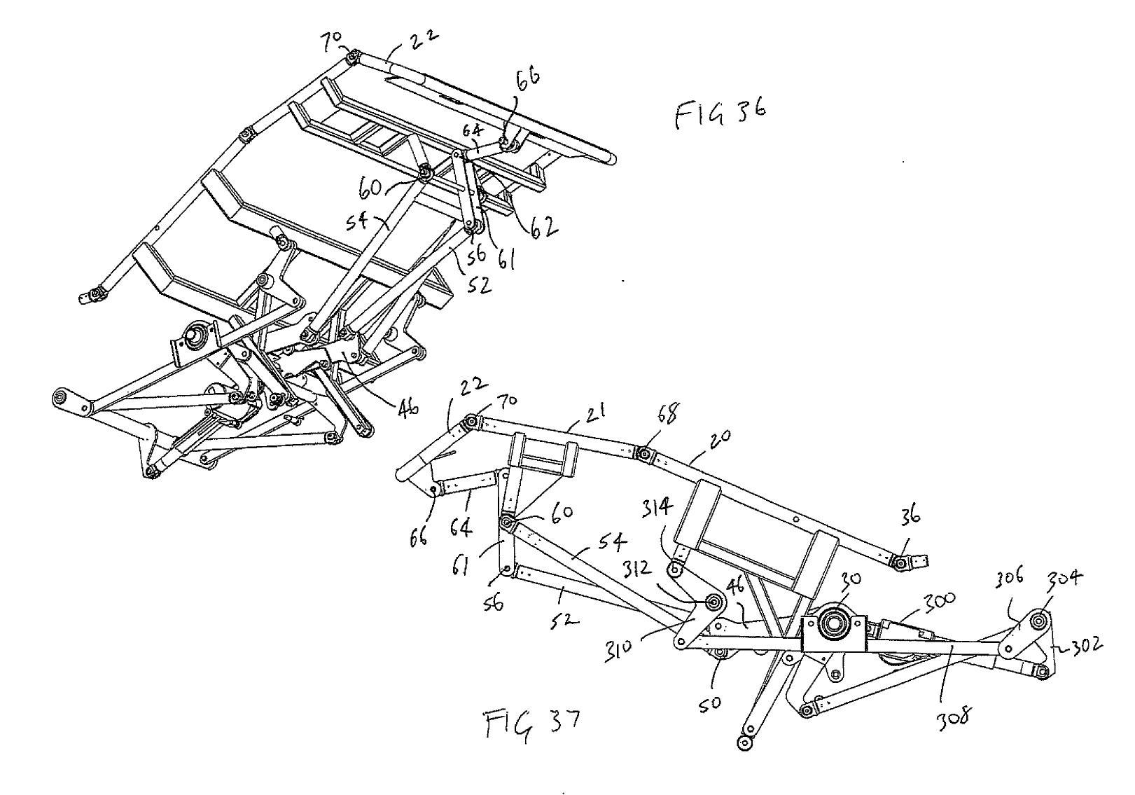

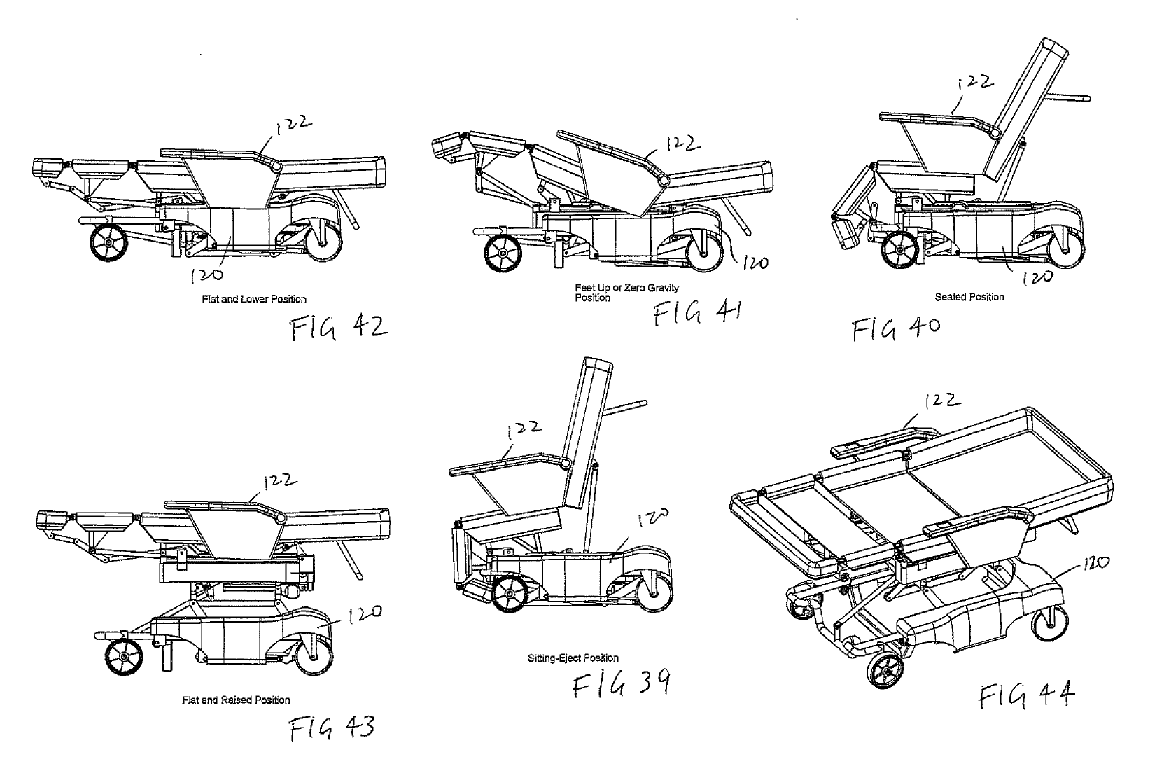

The articulation mechanism for this embodiment is essentially the same as that for the embodiments described above, but there is a difference in that this embodiment allows the seat portion to be raised significantly to provide a “feet up” or “zero gravity” position illustrated in FIG. 32. The mechanism by which this configuration is achieved is now described with referenced to FIGS. 36 and 37.

Turning now to FIGS. 36 and 37, the actuation mechanism features that have been previously described are denoted using the same reference numerals. The new features allow the seat portion to be tilted and the leg and foot portions 21 and 22 to be articulated relative to the seat portion such that the legs are in a comfortable raised position in which weight bearing forces are spread to minimise pressure points for a user.

The new features include an actuator 300 which acts between axle 30 and lever 302. Lever 302 rotates axle 304 which in turn moves lever 306. Link 308 is pivotally connected between lever 306 and one end of bell crank 301. The bell crank 310 is pivotally connected to the frame at connection 312 and to the seat portion at pivot connection 314. Thus the actuator 300 can be used to raise or lower the front of the seat portion 20 about pivot connection 26 and thus allow the desired “feet up” or “zero gravity” configuration to be achieved.

In FIGS. 39-44 another embodiment is shown which is essentially the same as described with reference to FIGS. 2-7. However, this embodiment includes the actuation mechanism as described in the FIG. 30-35 embodiment including the mechanism described in connection with FIGS. 36 and 37 to allow the “zero gravity” configuration (see FIG. 41). This embodiment includes a safety/cosmetic covering 120, and armrests 122 which may be varied in height. It will be appreciated that one or more of the wheels 24 or 19 of this apparatus may be driven by a motor (not shown) which may be controlled by a user.

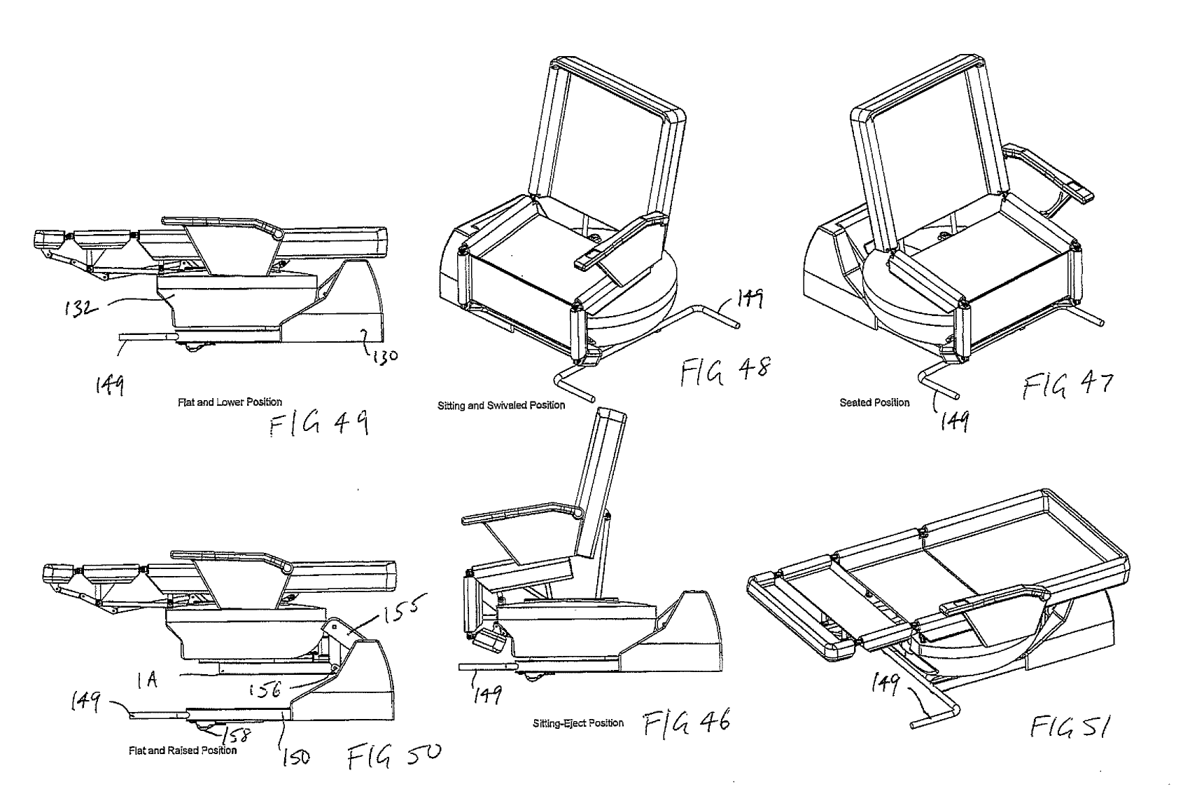

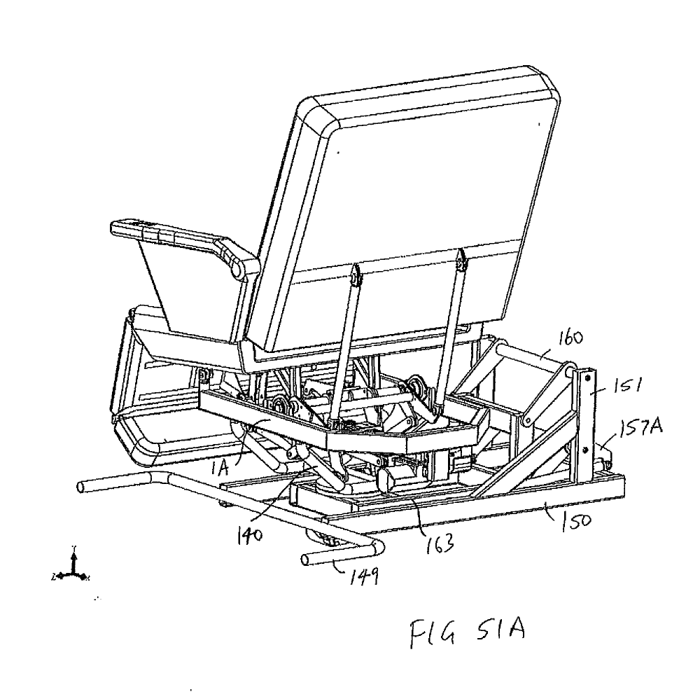

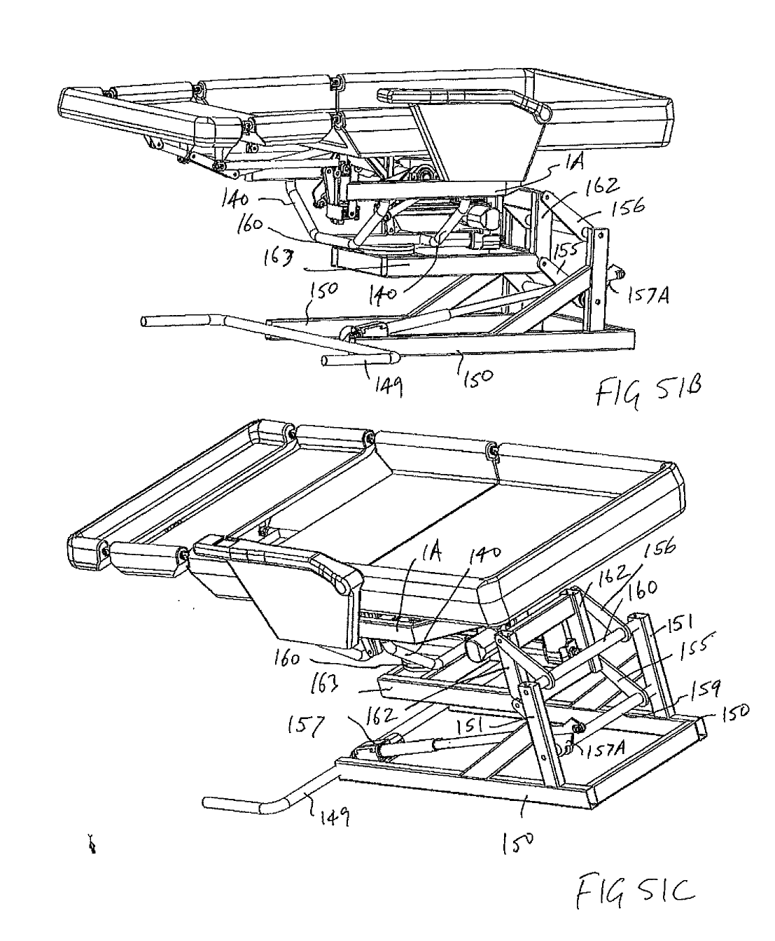

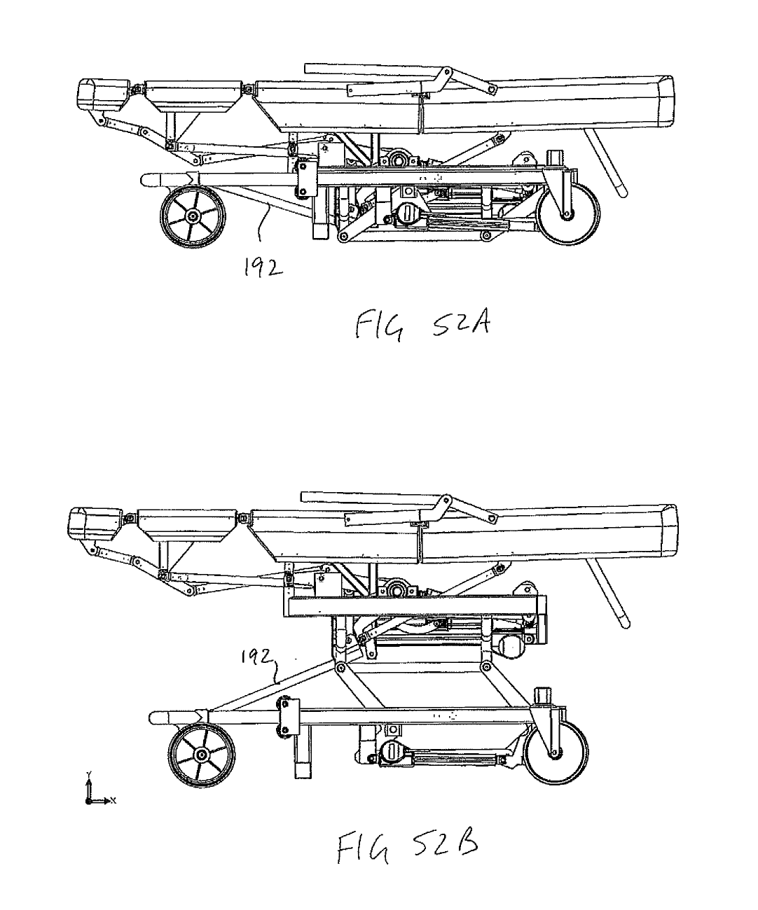

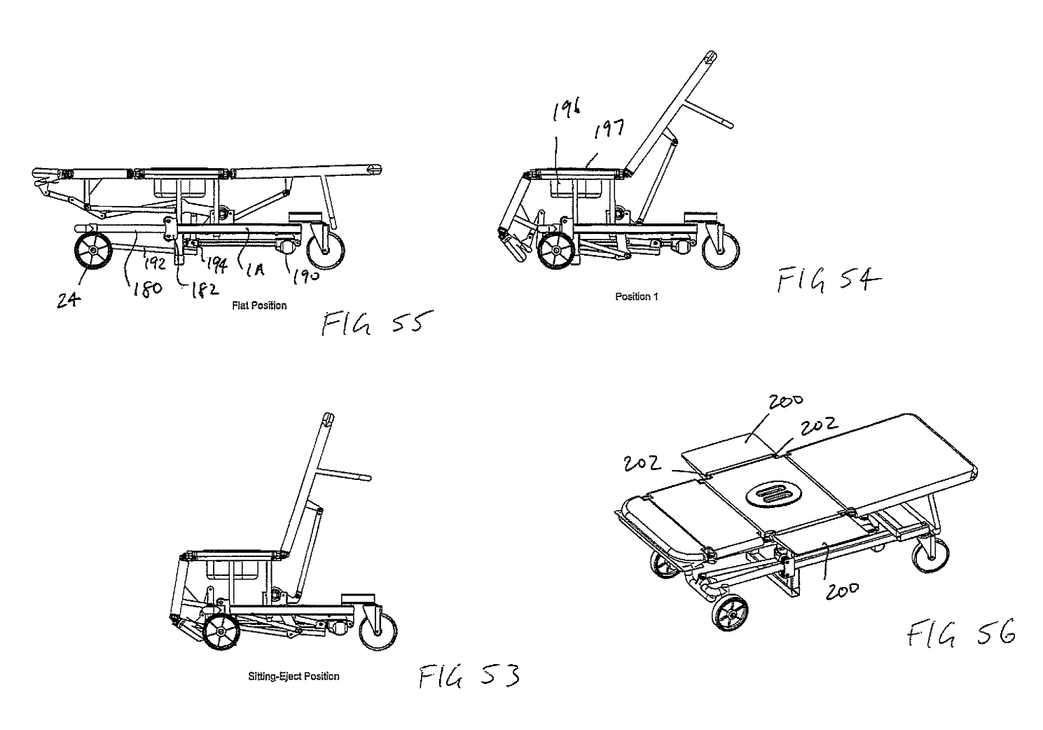

Another embodiment is shown in FIGS. 46-51C in which the support frame is pivotally mounted relative to the base frame assembly about a vertical axis so that the bed chair apparatus can swivel with respect to the base frame assembly. The base frame assembly is not clearly shown in FIGS. 46-51 but can be seen more clearly in FIGS. 51A-51C. In FIGS. 51A-51C the coverings 130 and 132 around the lifting mechanism and articulating frame parts are removed to reveal further detail. As can be seen from the drawing figures, the support frame including members 1A may be raised or lowered with respect to the base frame and the support frame can swivel with respect the base frame assembly. As with the other embodiments, such as the FIG. 30-35 embodiment for example, the support frame assembly supports the user support surface. It also supports the actuators (including optionally the manual actuation lever described in the FIG. 2-7 embodiment) and interconnected links and levers required to controllably articulate the support surface. The base frame assembly comprises base members 150 to which upright posts 151 are connected. An extension bar 149 contacts the floor adjacent the apparatus in order to provide additional stability when the apparatus is under load and thus prevent the apparatus from overbalancing. Posts 151 are spanned by axles 159 and 160. A base sub-frame is provided comprising upright members 162 and bearers 163. Links 155 are connected at one end to axle 159 and are pivotally connected at the other end to the upper ends of uprights 162. Links 156 are connected at one end to axle 160 and are pivotally connected at the other end to the lower ends of uprights 162. Links 155 and 156 therefore act to interconnect the uprights 151 and 162 so that they are constrained to move in a substantially parallel range of movement.

Actuator 157 is pivotally connected between one of the base frame members 150 and a lever 157A which is connected to axle 159. Extension of actuator 157 rotates axle 159 which in turn rotates links 155 and 156 so that the sub-frame members 163 are raised relative to the base frame members 150.

FIGS. 51A-51C also show the swivel joint 160 the base of which is supported by the subframe bearers 163. The upper side of the joint 160 is connected to frame members 140 which comprise part of the support frame, being connected to frame members 1A. The swivel joint may take forms other than that illustrated.

The base frame 150 may also include wheels or castors 158 to enable the apparatus to be moved easily if required.

Another embodiment is shown in FIGS. 53-56 in which the bed chair apparatus includes a commode. Referring to those Figures, once again like reference numerals are used to refer to like reference features discussed in previous embodiments. Although the apparatus shown in this embodiment is similar to the embodiment of FIGS. 2-7, it includes an actuation mechanism as described in the FIG. 15-20 embodiment, rather than using a hand operated lever to articulate the support surface between the required configurations. It will also be seen that the apparatus of this embodiment includes an extension frame part 180 which carries wheel 24. Extension frame part 180 extends from support frame member 1A (on each side of the apparatus) via guide 182. As can be seen, the frame part 180 is extended when the apparatus is in the bed configuration. This assists in preventing the apparatus from tipping when weight is placed on the foot portion when the apparatus is in the bed configuration. Therefore, the apparatus has the advantage of increased stability and safety. Frame part 180 retracts back into the support frame assembly when the bed chair apparatus is in the chair configuration.

The extension and retraction process is performed by using actuator 190. A link 192 is pivotally connected between the actuator arm and the wheel 24 at pivot connection 194. FIGS. 52A and 52B show the movement of link 192 more clearly between the raised and lowered positions. The swivel action of link 192 allows the frame to move to prevent overbalance even in the high position.

Although the extension frame mechanism is only shown on this embodiment, it may be used on any of the other embodiments disclosed herein, as may other features shown in the various embodiments described.

Another significant new feature of the apparatus shown in FIGS. 52-56 is the inclusion of a commode arrangement which includes a toilet bowl 196 and cover 197. Both the bowl 196 and the cover 197 are removable from the seat portion 20.

Yet another significant new feature of the apparatus shown in FIGS. 52-56 is transfer wings 200 which are pivotally connected at 202 to each side of the seat portion 20. The arrangement is such that the wings 200 can be folded inwardly to sit on the seat portion 20 if required, but can also adopt the position shown in the drawings. As a further option, the transfer wings 200 may be provided as armrests (i.e. be capable of adopting an intermediate orientation in which they are at right angles to the plane of the seat portion and thereby allow a user to rest his or her arms on an edge of the wings, or at least provide support to help prevent a user from falling off the apparatus). Wings 200 may also drop vertically if required, and may be separate from the arm rests.

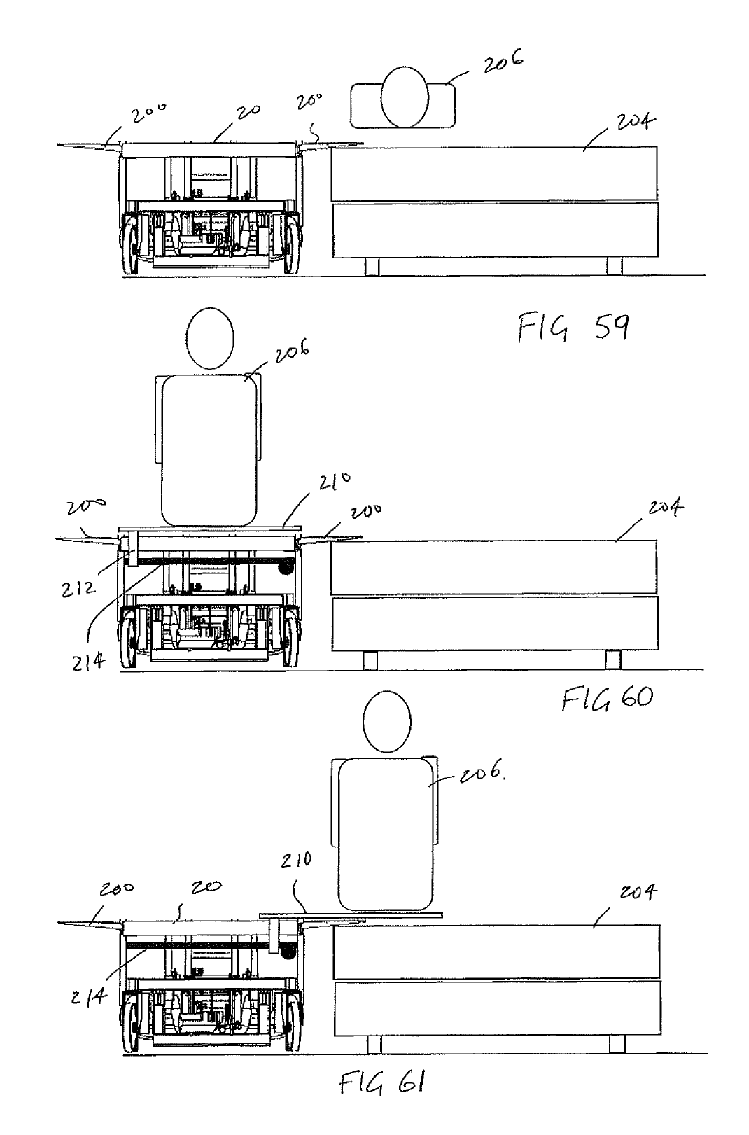

In use, when the transfer wings are in the orientation shown in the drawings, then they provide an extension surface so the a user can use one or both wings 200 as a bridge between the apparatus and another article of furniture (such as a bed 204) as shown in FIGS. 59-60.

In FIG. 59, the apparatus has been positioned to facilitate manual transfer of a user from the apparatus to bed 204.

In FIGS. 60 and 61, the bed chair apparatus is shown including another significant new feature, being a transfer platform 210 which is connected by leg 212 to an actuator 214. As shown in FIGS. 60 and 61, the actuator 214 can be operated to move platform 210 such that the platform extends onto, or over, the bed 204 (FIG. 61). In this way, a user of the bed chair can use powered assistance to transfer to or form another piece of furniture.

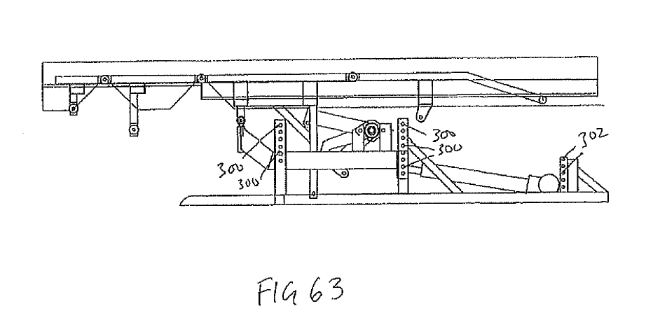

In FIG. 63 another embodiment is shown in which the height of the apparatus may be adjusted manually. The base frame and the support frame each include a plurality of apertures 300 some of which may be aligned at different vertical position to enable the height of the support surface to be adjusted. In this embodiment apertures 302 are also provided to allow the actuator to accommodate the change in height. In at least one other embodiment apertures 302 are not necessary.

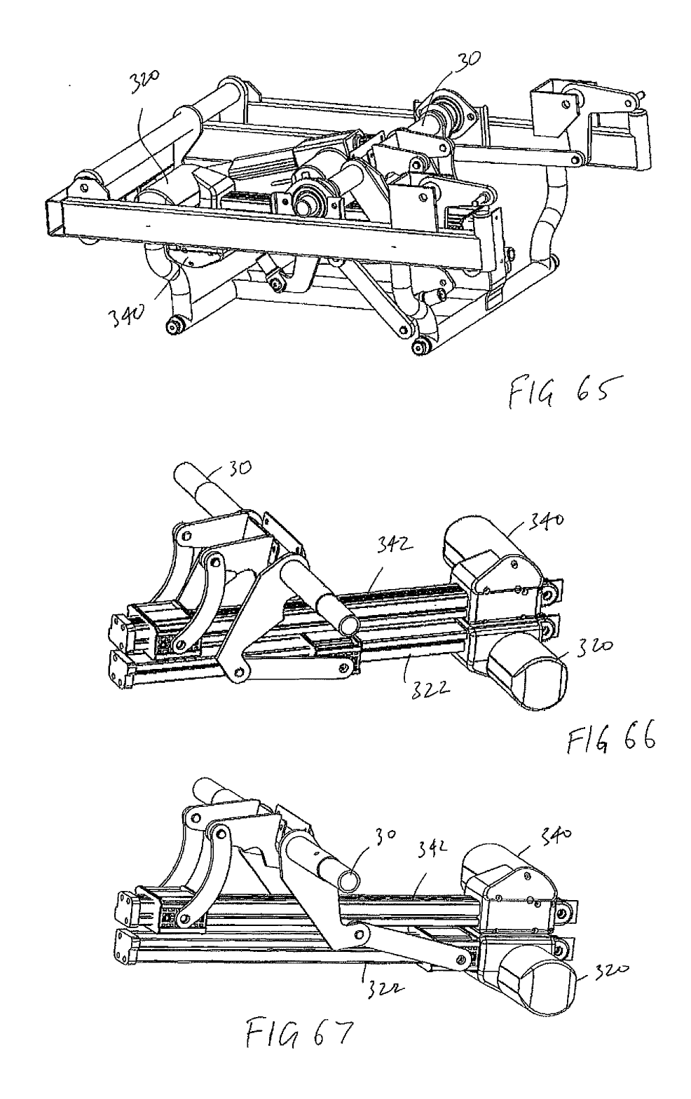

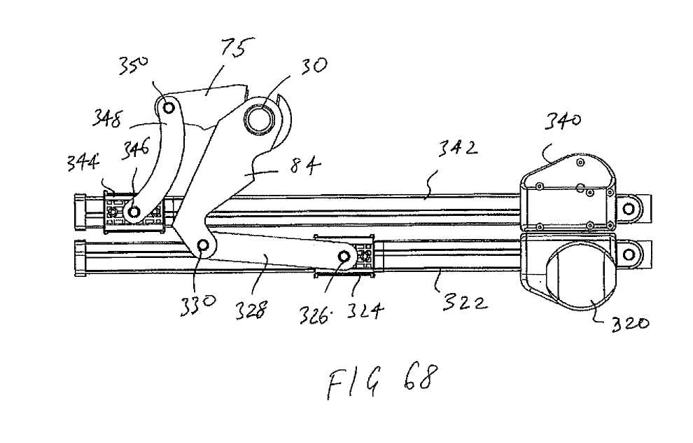

Turning to FIGS. 65-68, examples of articulation mechanisms using a different form of actuator are shown. In these embodiments the mechanism has the same effect as that in the embodiments described above. Like reference numerals are used to refer to like features between the embodiments. With these actuators shown in this embodiment, the actuators include a guide along which a carriage moves, rather than an extending telescopic arm.

Referring firstly to FIGS. 66-68, an actuator 320 has a guide 322 on which a carriage 324 is propelled. Because the actuator does not use an extendable arm, the actuator is shorter in the retracted orientation for a given range of movement than that of the actuator described in the previous embodiments. Carriage 324 is pivotally connected at 326 to link 328 which is in turn pivotally connected to lever arm 84 which rotates axle 30, as described in previous embodiments. Also, as described in previous embodiments, this single actuator may be used to perform the whole complete articulation process between chair and bed configurations.

FIGS. 66-68 show the use of an additional actuator 340, again having a guide 342 on which a carriage 344 is propelled. In some embodiments the guide members 322 and/or 342 may be sufficiently strong and rigid to comprise a part of the support frame.

Carriage 344 is pivotally connected at 346 to link 348 which is in turn pivotally connected to lever arm 75 which can be used to rotate bar 31 about axle 30 and thus provide the option of independent control of the back rest portion, as described in previous embodiments.

In FIG. 65, the actuators 320 and 340 are shown connected in the support frame.

For all of the embodiments discussed above, mechanisms may be used to prevent entrapment in the articulation mechanism. Entrapment can occur when a part of the user's body, or that of another person who is near the bed chair, becomes caught in the actuation process during the articulation process. The devices proposed herein to prevent entrapment include one or more of the following:
a) One or more touch sensitive pads can be used as a sensor which is coupled to the control mechanism or the relevant actuator. In this manner, a pad can be provided underneath the bed chair, so that when the pad is touched (indicating the presence of a person) the mechanism freezes, preventing articulation.
b) One or more beam sensors may be used. For example, an IR beam sensor may be placed so as to detect a person too close to the articulation mechanism, to thus prevent the mechanism from articulating.

Another option is to cover or enshroud the articulation mechanism.

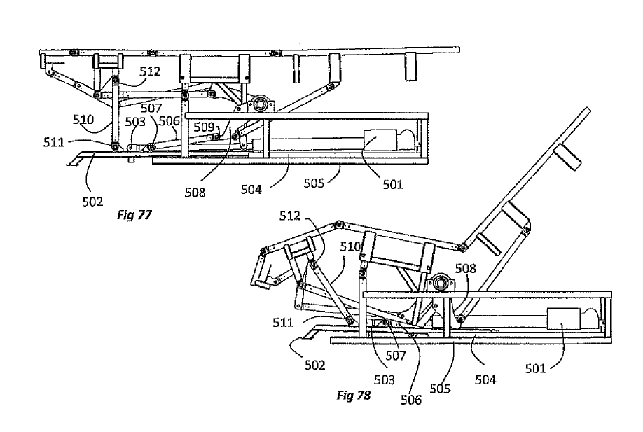

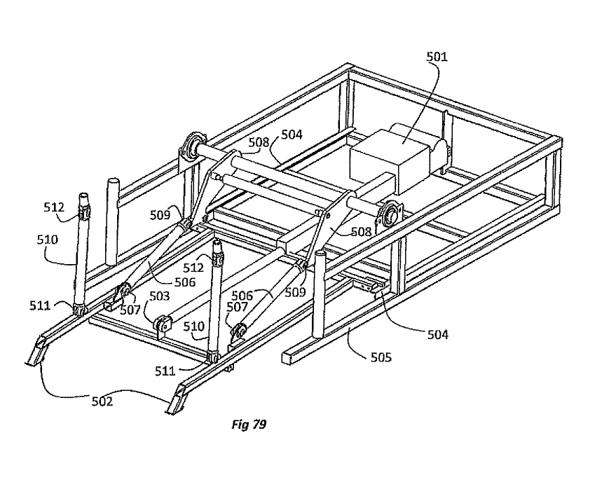

Turning now FIGS. 77 to 79, an embodiment is shown in which a sliding frame is nested within the base frame of the apparatus when the apparatus is in the chair position, but extends from the apparatus to provide additional support to prevent overbalancing when the apparatus is in the bed configuration. The extending frame is driven from an actuator which does not necessarily also drive the drive axle 30 referred to in the embodiments referenced above. However, those skilled in the art could see that the arrangement could be achieved using the same actuator used to turn the drive axle with appropriate modification. Therefore, referring to FIGS. 77 to 79, actuator 501 drives sliding frame 502 through pivotal connection 503. The sliding frame 502 slides in a track 504 which is connected to the base frame 505. Link 506 is pivotedly connected to the sliding frame 502 at pivot mount 507. Link 506 is pivotally connected to drive lever 508 at pivot connection 509. The front end of the sliding frame 502 has vertical support through linked bar 510 which connects pivotally to the sliding frame 502 at point 511. The other end of link bar 510 is pivotedly connected to the leg rest section at pivot connection 512.

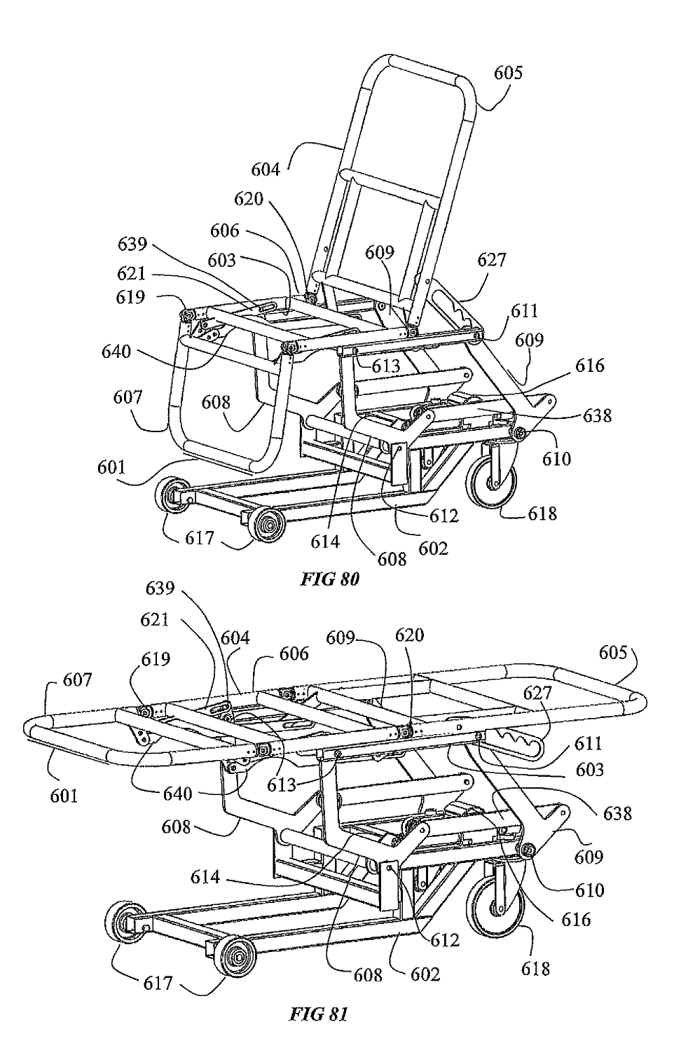

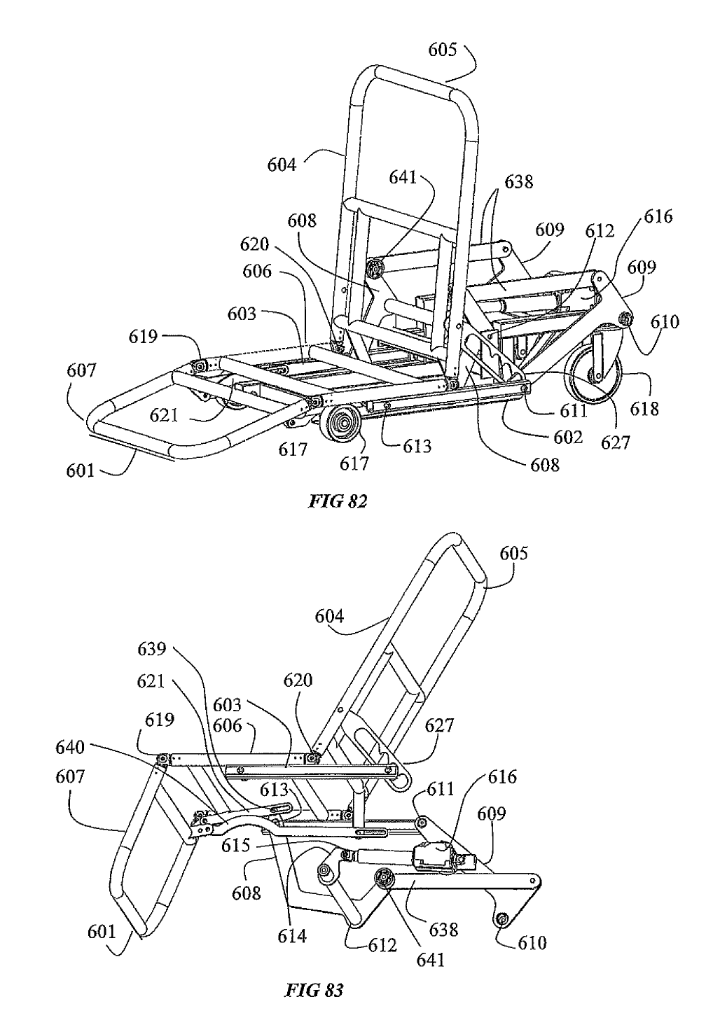

Referring now to FIGS. 80 to 83 another embodiment of the invention is illustrated in which a part of the bed chair apparatus is lowerable to floor level to facilitate entry and exit to the apparatus. This embodiment may be scaled down for use for children, but larger versions are available for adults and even obese persons. This embodiment also has application for people who are wheel chair bound, as it can enable them to move directly onto or off the floor surface and into the bed chair apparatus. Similarly, once in the bed chair apparatus, the bed chair can be used in some embodiments as a wheel chair, as will be described further below.

Furthermore, such a person can more easily transfer from the bed chair apparatus to a dedicated wheel chair.

Although the embodiments shown in FIGS. 80 to 83 has three articulating sections, those skilled in the art will appreciate that the invention may be applicable to support surfaces which have a greater number of articulating sections, as described above. Referring to the present embodiment, the apparatus has a base section 602, a mid section 603 and a mattress platform 604. The mattress platform includes a back rest 605, seat section 606 and leg portion 607. The mid-section is linked to the base by levers 608 and 609 which pivot about pivot points 610, 611, 612 and 613. Pivot point 612 is a drive axle which is rotated by drive lever 614, which in turn pivots at 615 and is driven forward and back by an actuator 616. The forward and back extension movement of actuator 616 causes the mid section 603 to raise and to lower. In an alternative embodiment, pivot 610 comprises a drive axle, to which lever 614 and an actuator 616 are attached to perform the required movement. The base section has wheels 617 at the front and wheels 618 at the rear to enable the apparatus to be moved. As with other embodiments, the wheels 617 and/or 618 may be motorised if required. The leg section 607 is pivotally connected to the seat section 606 at pivot 619. The seat has a pivot connection 620 to the back 605. The leg rest section 607 folds and unfolds by the use of a lever system integrated into both sides of the support surface or mattress. Back rest support lever 627 pivots off the back rest and has teeth which engage in the middle frame 603 to support the back rest at a range of angles.

Leg rest lever 621 pivots from the leg rest 607 and attaches pivotally to the end of lever 608 at pivot point 639. Because pivot point 639 is offset from pivot point 613 as the seat rises the leg rest folds and unfolds. A slot in 621 allows for alternative movement and prevents entrapment under the lowering leg rest.

Link bar 640 connects the leg rest 607 to the back rest 604 to synchronise the raising of the leg rest to the lowering of the back rest. Link bar 640 is slotted to allow for alternative back rest positions as required and supported by back rest support lever 627. As the back rest lowers wheel 641 engages with the rear of the back rest 604 to help raise and give support to the back rest.

The padding on the mattress of the device may comprise foam in one embodiment with a cover. In another embodiment a polyurethane mould of form may be provided. In yet further embodiments the mattress may have an air tight bladder with a valve and/or polystyrene beads within the mattress. These can be configured to the desired shape which may be made rigid by use of a vacuum to extract air from the bladder through a valve. For example if the apparatus is used for a growing child who has a disability, then the mattress through use of beads can be configured to accommodate the child's body as the child grows. Therefore, in one example, the child may be positioned on the mattress in a desired posture, then air can be removed through the valve using an appropriate pump (possibly a vacuum cleaner for example). In this manner the mattress is set to the desired form or shape for the child at that stage of the child's growth. The mattress shape can be changed periodically as the child grows.

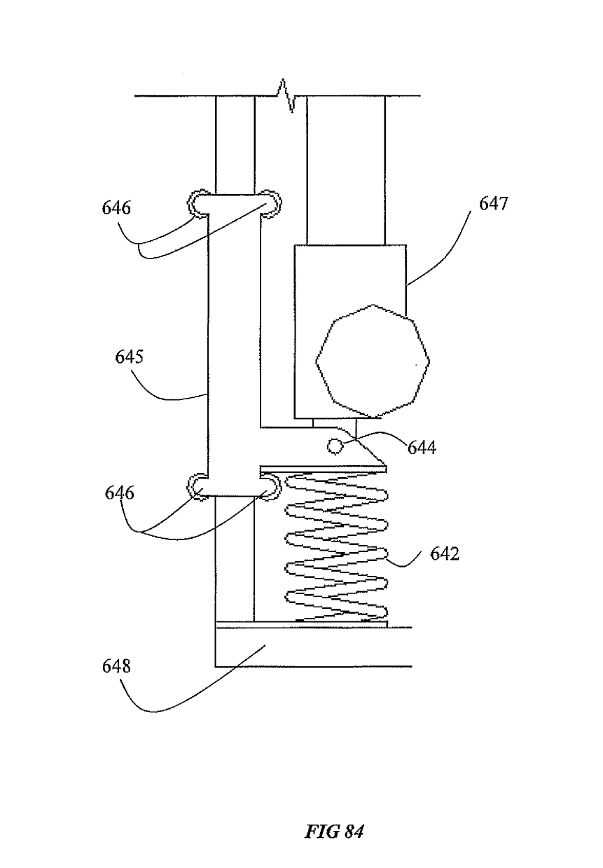

FIG. 84 shows a suspension system for the actuator to absorb the impact of a person falling into the seat of the bedchair. A system as shown in FIG. 84 may be optionally used anywhere an actuator 647 is mounted to the bedchair. The lower end of the actuator is mounted at 644 to a sliding carriage 645 which has roller wheels 646 at each end which slide up and down a part of the bedchair frame 648. A spring 642, or spring-like device, is mounted between the actuator mount 644 and frame 648.

As with other embodiments, a sensor 601 may be used at an end of the leg rest section 607 in order to sense impending entrapment. Other features of the preceding embodiments may also be included in this apparatus, which as can be seen has an advantage of being able to be lowered to floor level.

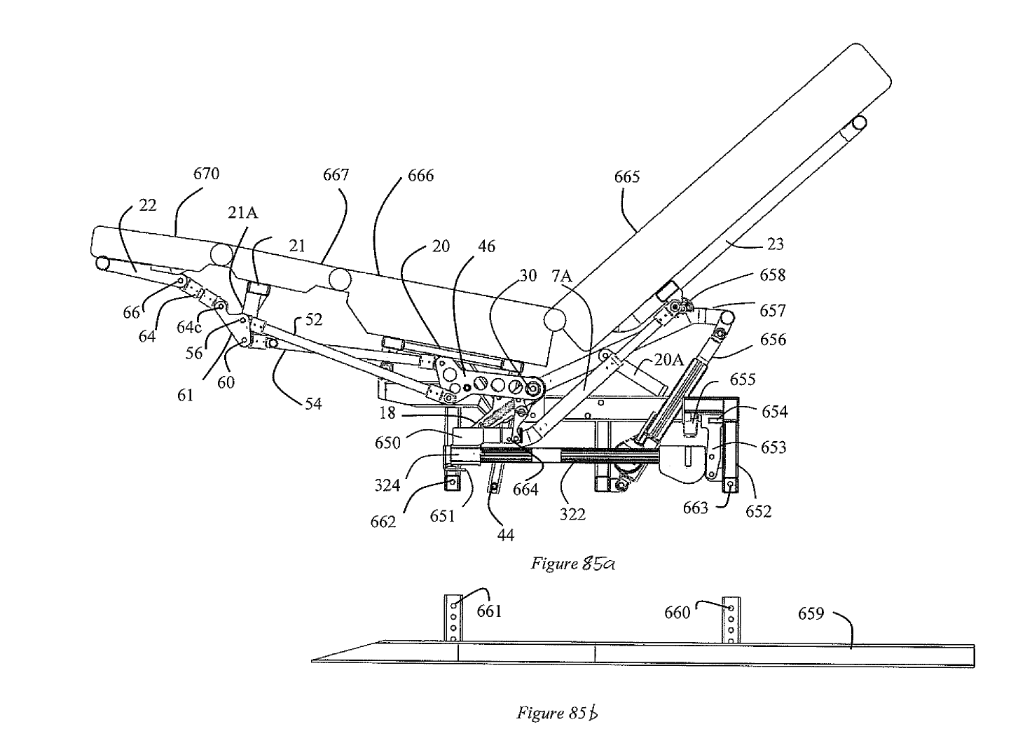

Turning now to FIGS. 85a and 85b, an embodiment is illustrated which offers an alternative arrangement for preventing entrapment of an object below the leg rest section 21 when the leg and footrest 22 close into the chair position. Actuator 322 is mounted slidably on bracket 651. The other end of actuator is mounted pivotally on lever 653 which in turn is mounted to the middle frame 652. The other end of lever 653 is positioned opposite limit switch 655. Lever 653 is held in tension against the middle frame 652 by means of a spring 654. The tension of spring 654 can be adjusted to suit the user's needs. If additional resistance is encountered as the leg and foot rest close into the chair position, the actuator will be pulled towards the foot end of the bed, whereby the lever 653 will then press upon the limit switch 655 which then stops and or reverses the action of the actuator to prevent entrapment.

The embodiment of FIGS. 85a and 85b also includes a back rest support bar assembly which provides additional control of the angle of the back rest section of the mattress. Back rest support bar 657 is mounted pivotally to Axle 30. Support bar 657 can be raised or lowered by actuator 656, or alternatively raised or lowered by hand and held in place by bracket 20A which pivots from back rest support bar 657 and locates into any one of a number of fixing points on middle frame 652. Back rest frame 657 has a wheel or rub plate 658 which may rest on support bar 657. back rest link 7A is optionally telescopic and fixes pivotally between the back rest frame 23 and the lever 18 on the drive axle 30. Back rest support bar 657 can be set at an angle so that when the mattress frame 23 is lowered the wheel 658 comes to rest on support bar 657 therefore preventing the mattress frame 23 lowering further. The telescopic back rest link 7A then elongates as the levers on drive axle 30 continue to rotate. Alternately actuator 656 can be fitted to control the elevation of the back rest support bar 657 in a powered manner.

Articulation of the levers and links regulating movement of the leg rest and foot rest has been explained earlier in this patent specification. However, FIG. 85a also shows that link 52 might connect to the rocker lever 61 at the mid-point 56. The previous embodiment had link 52 connecting to rocker bar 61 at 60. Thus it will be apparent from this embodiment that the rocker bar 61 can connect to the underside of the leg rest 21A at either point 60 or alternatively point 56.

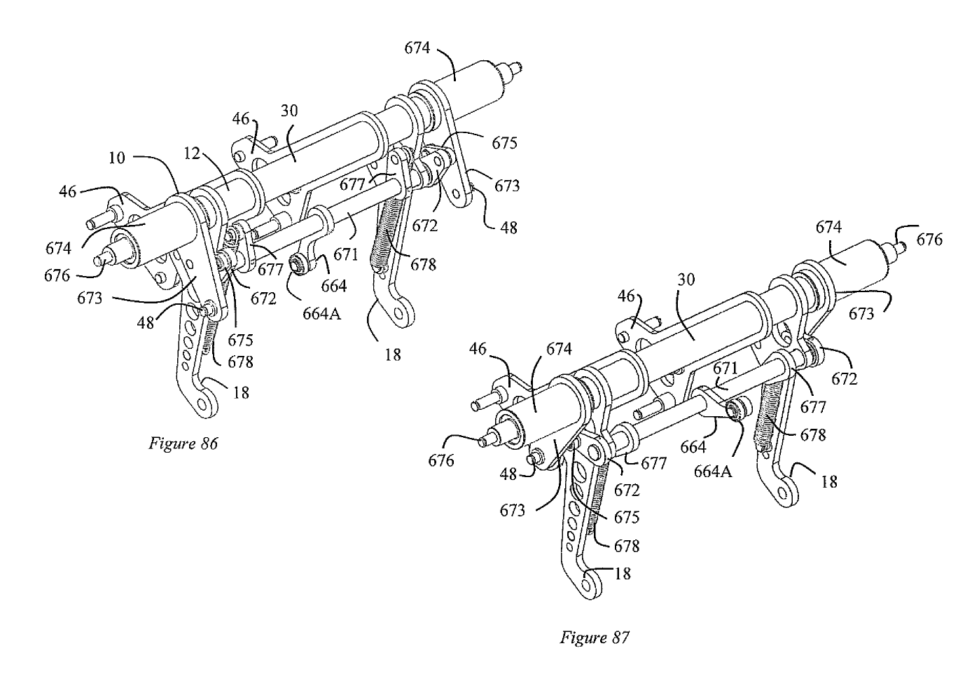

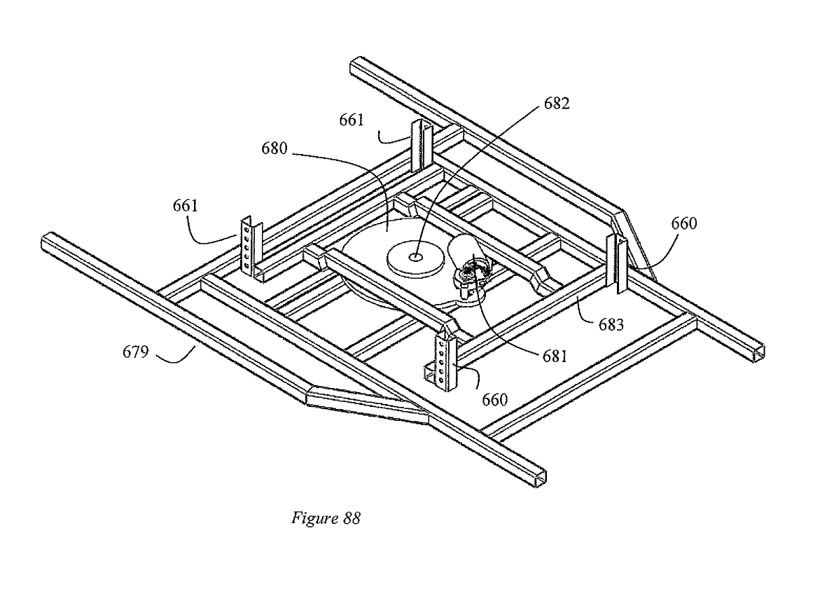

FIG. 85a shows a stirrup 650 which is fitted to actuator carriage 324. Toward the end of the actuator stroke the stirrup engages with and rotates lever 664 which though an optional mechanism detailed in FIGS. 86 and 87 (described further below) causes movement to the link which connects to point 44 and therefore enables additional tilt of the seat section. Also, because the leg and foot rest are connected to the seat section of the mattress platform they also tilt additionally.

Referring again to FIG. 85a, 670 is the foot rest part of the mattress. This has a flexible connection to the leg rest mattress part 667 which in turn has a flexible connection the seat rest mattress part 666 which in turn has a flexible connection to the back rest mattress part 665. Each mattress part has a hard surface such as plywood 710 (refer FIG. 96) glued or otherwise affixed to the bottom surface and all of the above are enclosed within a stretchable cover to form the complete mattress which then fixes to the mattress platform with bolts or other quick release fixing. This enables the complete mattress to easily be removed and exchanged.

FIG. 85b shows a simple base frame module that can attach to and give stability to the middle frame. Frame 659 is the base frame which has points 660 and 661 where the middle frame can attach.

FIG. 86 shows an activated position of the optional additional tilt mechanism, and FIG. 87 shows the mechanism in a ready position. When the Bedchair has achieved the bed position where the seat, leg and footrest are substantially aligned and horizontal, further articulation can be achieved by utilising additional stroke of the existing single actuator to create an additional action upon the mattress platform where the seat, leg and foot rest tilt so as to elevate the legs of a person laying on the mattress. FIG. 85a shows that as the carriage 324 on the actuator 322 moves, the stirrup 650 engages with wheel 664A which in turn rotates lever 664 and further axle 671. Axle 671 is mounted on levers 18 and can rotate within a bush mounted on that lever. Axle 671 rotates lever 672 which links pivotally though link 675 to lever 673. Lever 673 can rotate independently about the drive axle 30. Pivot point 48 is linked to link 42 (refer FIG. 7D) which links to the seat rest strut 2 at point 44.

Lever 677 is fixed to the axle 671 and has a spring 678 attached which anchors to lever 18. The purpose of this spring is to hold the mechanism in the ready position (FIG. 87) until such time as stirrup 650 connects with the lever 664 and is rotated (FIG. 86) causing the mechanism to activate and therefore put the spring in tension.

As the stirrup 650 on the actuator carriage engages with the wheel 664A the lever 664 rotates the legs elevation mechanism causing the seat to tilt. As the seat is also connected to the leg and footrest these also tilt when this mechanism is activated.

Turning now to FIG. 88 a swivel base frame module is shown which is easily attachable at to the middle frame module shown in FIG. 85a. Base 679 provides stability, fixed to it are two swivel plates 680 mounted centrally and pivoting around 682. Optionally one of the swivel plates has a toothed surface which engages with a cog mounted on the second plate. Such a cog or gear might be driven by a motor 681 mounted on the second plate which fixes to the swiveling attachment frame 683 which has attachment points 660 and 661 which then are easily attachable to the middle frame shown in FIG. 85a. This provides the Bedchair mattress an unlimited rotation clockwise and anti-clockwise while configured in any bed, recliner or chair orientation. This provides the user with alternative views from the Bedchair. Rotation of the Bedchair might also provide better access to items like a desk, exercise equipment, transfer devices or a commode.

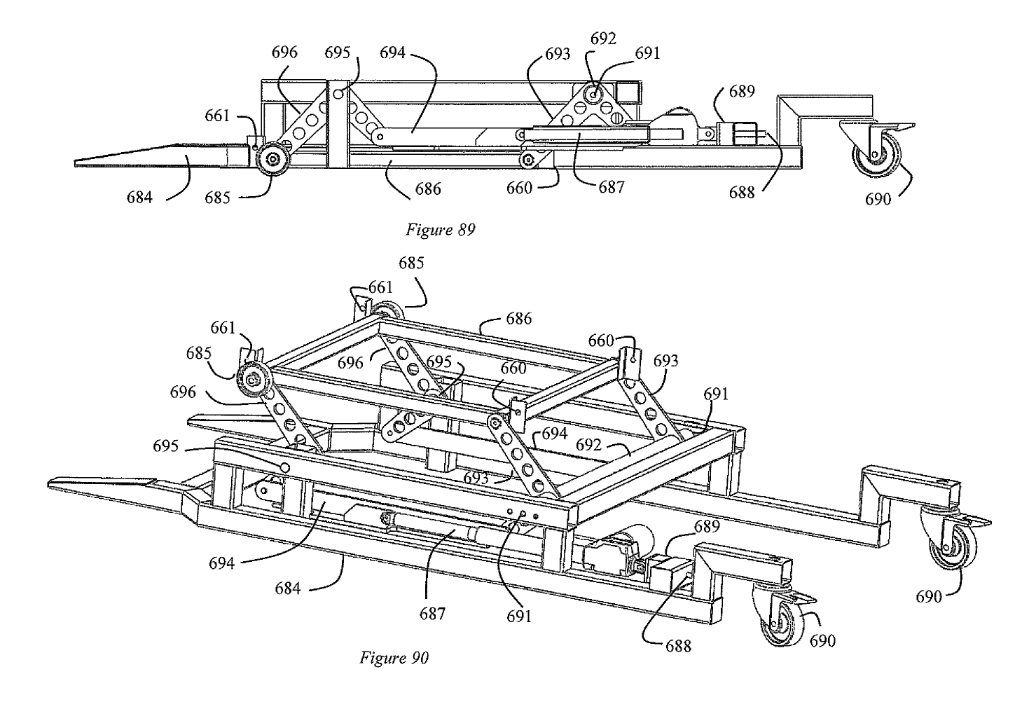

FIGS. 89 and 90 show an adjustable height base frame module which is easily attachable to the middle frame module shown in FIG. 85a. A base 684 provides stability. Rotably connected to this is an axle 692 which turns L shaped levers 693 which are linked by link bars 694 to levers 696. Levers 696 pivot about points 695 on the frame 684. An actuator connects to one of the links 694 to cause rotation of the levers 696 and 693 causing the frame 686 to raise and lower. Attached to frame 686 are attachment points 661 and 660 where the middle frame and mattress shown in FIG. 85a might easily attach.

The actuator 687 is mounted on plate or rod 688 which is mounted to or though a shock absorbing block such as rubber or urethane which then attaches to the base frame 684. The purpose of this type on mount is to absorb the shock of a person falling onto the mechanism.

Wheels 685 are attached to the levers 696 and or levers 693 so that when these levers are lowered the frame 684 is raised and so making the frame mobile. Wheels 690 make the frame mobile at the rear.

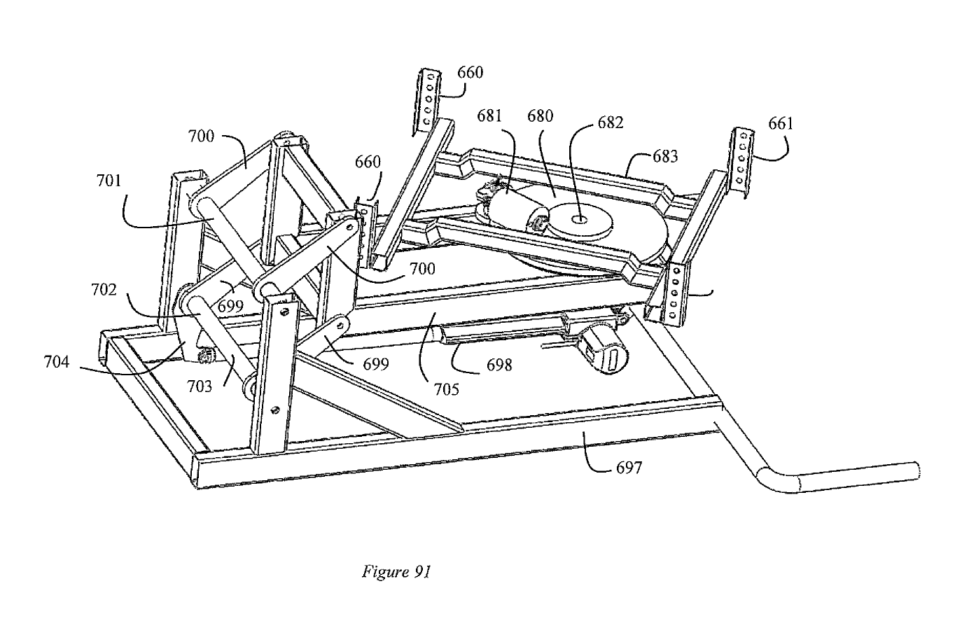

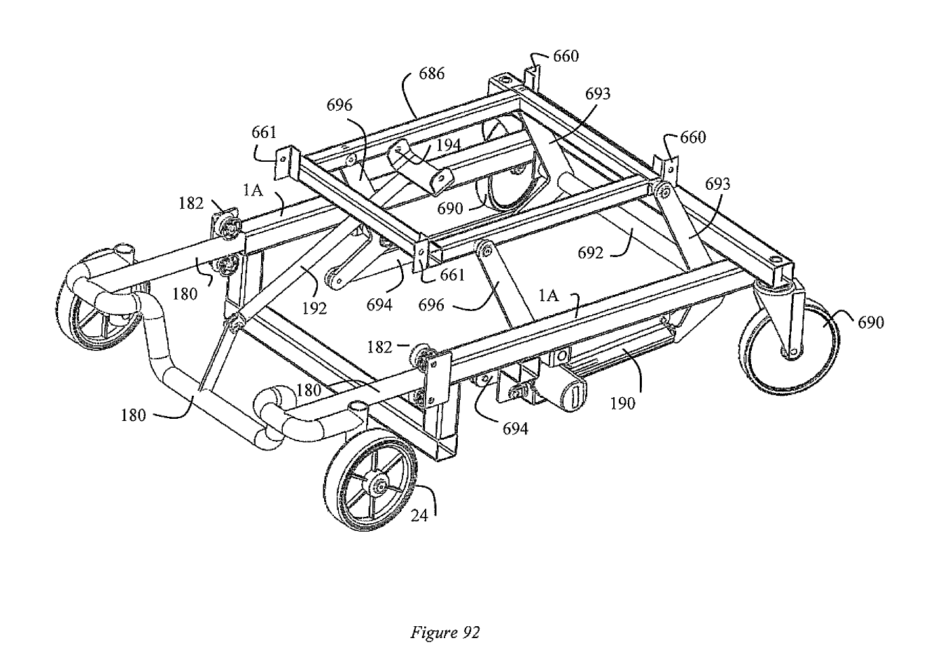

FIG. 91 shows an embodiment having an adjustable height base frame module with a swivel attachment frame. The standard mattress and middle frame can be fitted to a number of different bases to enable the Bedchair to be sold with different features by simply attaching a different base.

The adjustable height swivel base frame shown in FIG. 91 provides the bedchair mattress at least 180 degrees of rotation clockwise and anti-clockwise while configured in any bed, recliner or chair orientation. This provides the user with alternative views from the bedchair. Rotation of the bedchair might also provide better access to items like a desk, exercise equipment, transfer devices or a commode. A base 697 has axle 703 with levers 699 and axle 701 with levers 700 mounted rotatably and oriented one axle above the other. Levers 699 and 700 connect pivotally to the second frame 705 which has the swivel mechanism attached as described in FIG. 88. The middle frame with mattress attaches at points 661 and 660.

FIG. 92 shows an adjustable height base frame module with telescopic mobile base.

The standard mattress and middle frame can be fitted to a number of different bases to enable the bedchair apparatus to be sold with different features by simply attaching a different base. This base has wheels to make the bedchair mobile and compact while in the chair position and yet also with an extended/lengthened telescopic base to make it stable when in the bed position. A base frame 1A has wheels 24 and 690 for mobility. Axle 692 is fixed rotatably to the frame 1A and has levers 693 which links 694 connect to levers 696 which fix pivotally to attachment frame 686 which is then raised or lowered as actuator 190 is activated. Actuator 190 is attached to one of the links 694 and at the other end to the frame 1A. Base frame 180 telescopes inside frame 1A. Frame 180 connects to link 192 which connects to the actuator carriage 324 (refer FIG. 85a) Actuator 322 then drives the frame 180 in and out telescopically to lengthen or shorten the base frame length as the bedchair articulates.

FIG. 93 shows an adjustable height base frame module with sissor action base with the actuator mounted vertically at one end. The middle frame with mattress attaches at points 661 and 660. The standard mattress and middle frame can be fitted to a number of different bases to enable the Bedchair to be sold with different features by simply attaching a different base.

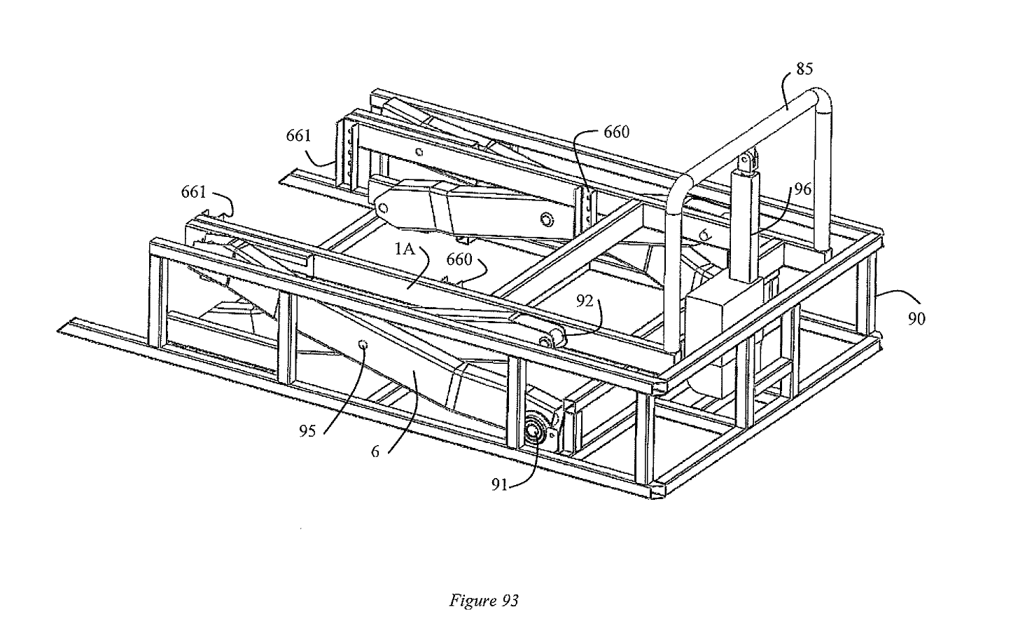

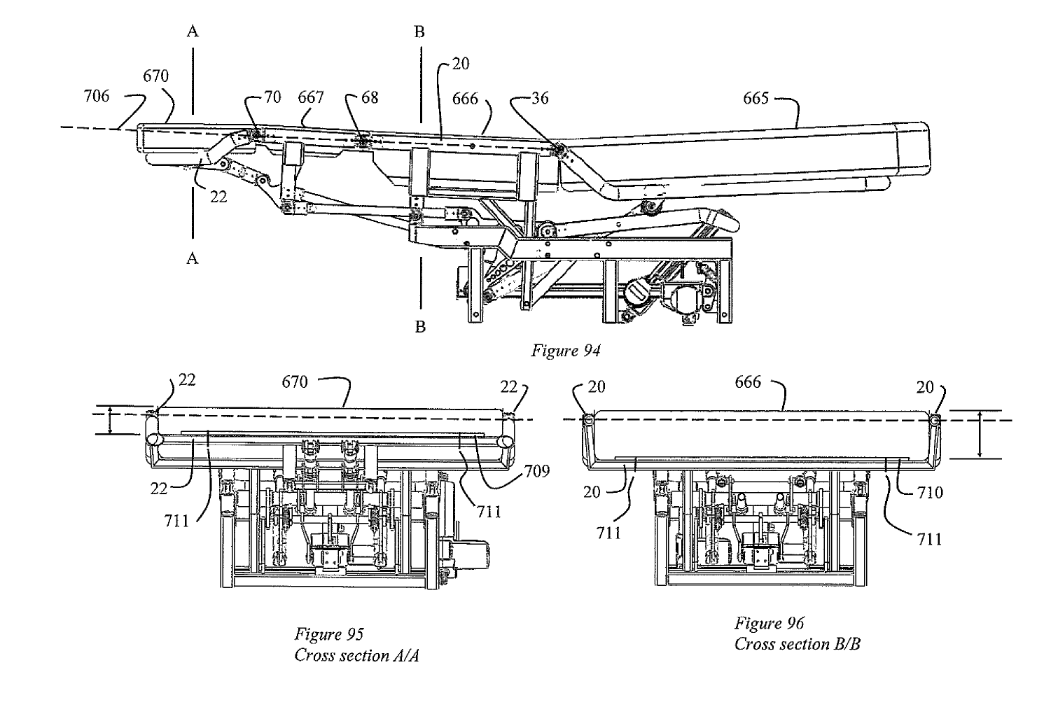

FIG. 94 shows a side view of the mattress showing the hinge points in alignment. Broken line 706 shows the centre line though the hinge points 70, 68 & 36 of the mattress platform frame when the bedchair is in the bed position. This shows that all three hinge points are at a substantially equal distance from the top surface of the mattress.

The foot rest part 670 of the mattress has a flexible connection to the leg rest mattress part 667. This in turn has a flexible connection the seat rest mattress part 666 which has a flexible connection to the back rest mattress part 665. Each mattress part has a hard surface such as plywood 710 (refer FIG. 96) glued or otherwise affixed to the bottom surface and all of the above are enclosed within a stretchable cover to form the complete mattress which then fixes to the mattress platform with bolts or other quick release fixing 711. This enables the complete mattress to easily be removed and exchanged. Foot section 22 of the mattress frame platform connects to the leg section 21 (refer FIG. 7D) at 70. The leg section connects at 68 to the seat frame 20 which connects to the back rest frame 23 at hinge point 36.

FIG. 95 is a cross section through the foot section of the mattress at A-A on FIG. 94.

The broken line which runs through the centre of the hinge points 70 shows that the centre of the hinges are at least above the centre of mass of the mattress, and that the mattress fits between the hinge points.

FIG. 96 is a cross section though the seat section of the mattress at B-B on FIG. 94.

The broken line which runs through the centre of the hinge points 68 and 36 shows that the centre of the hinges are at least above the centre of mass of the mattress and that the mattress fits between the hinge points.

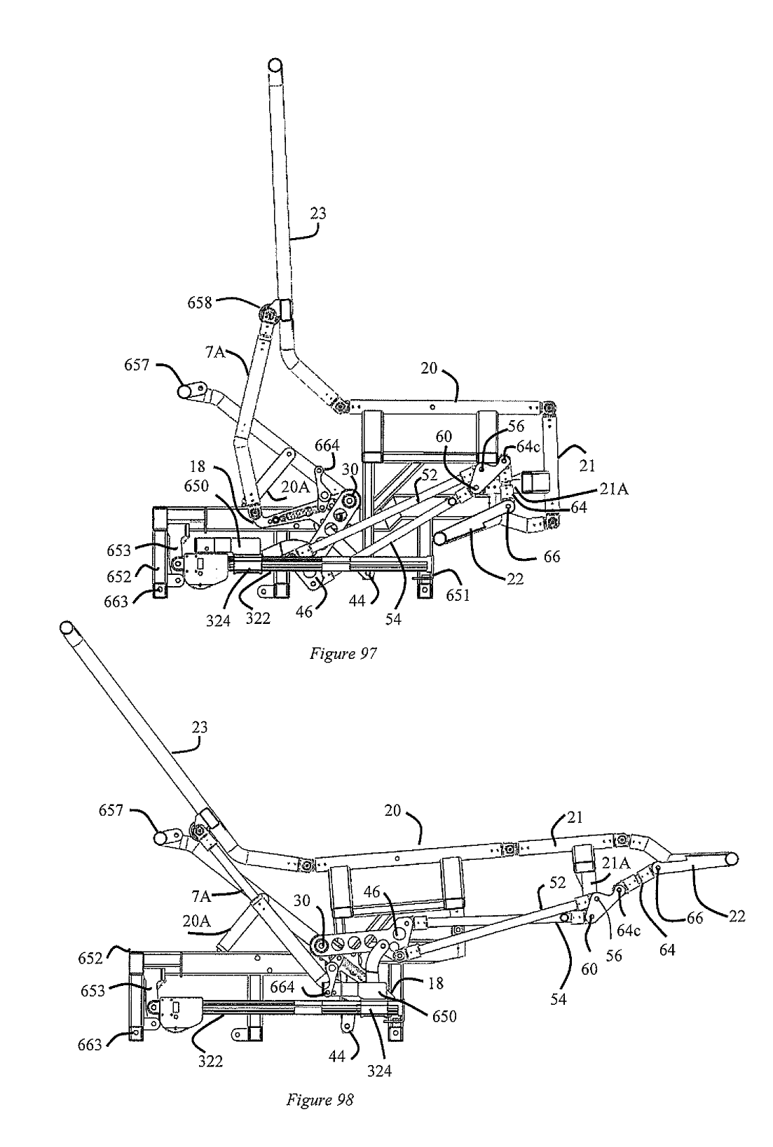

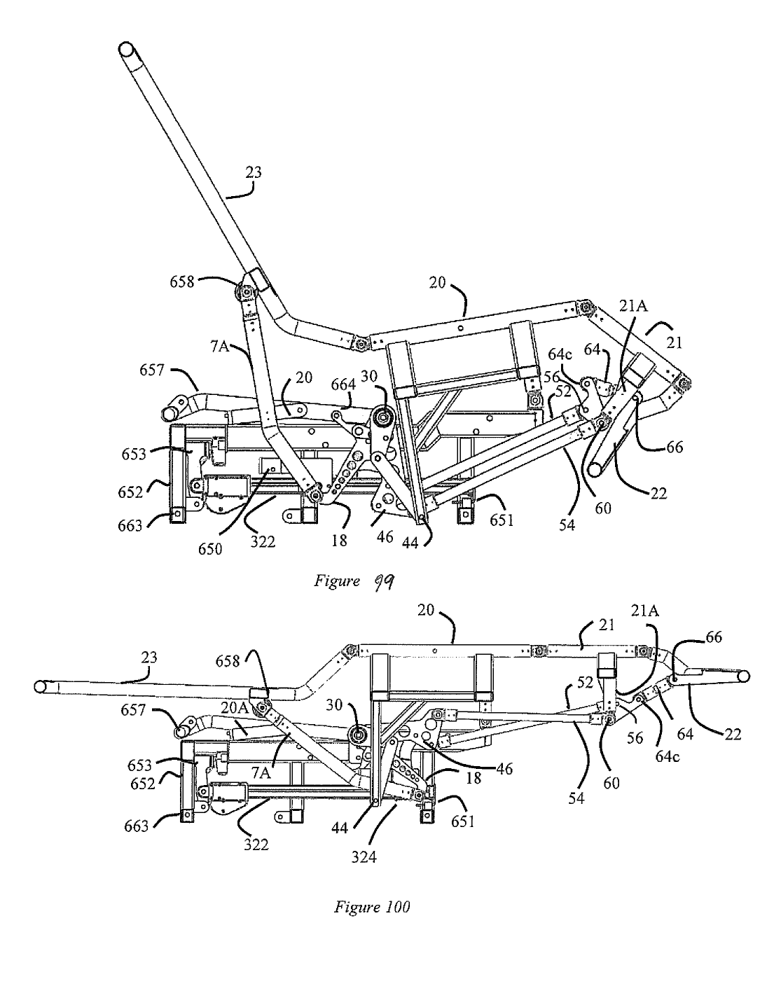

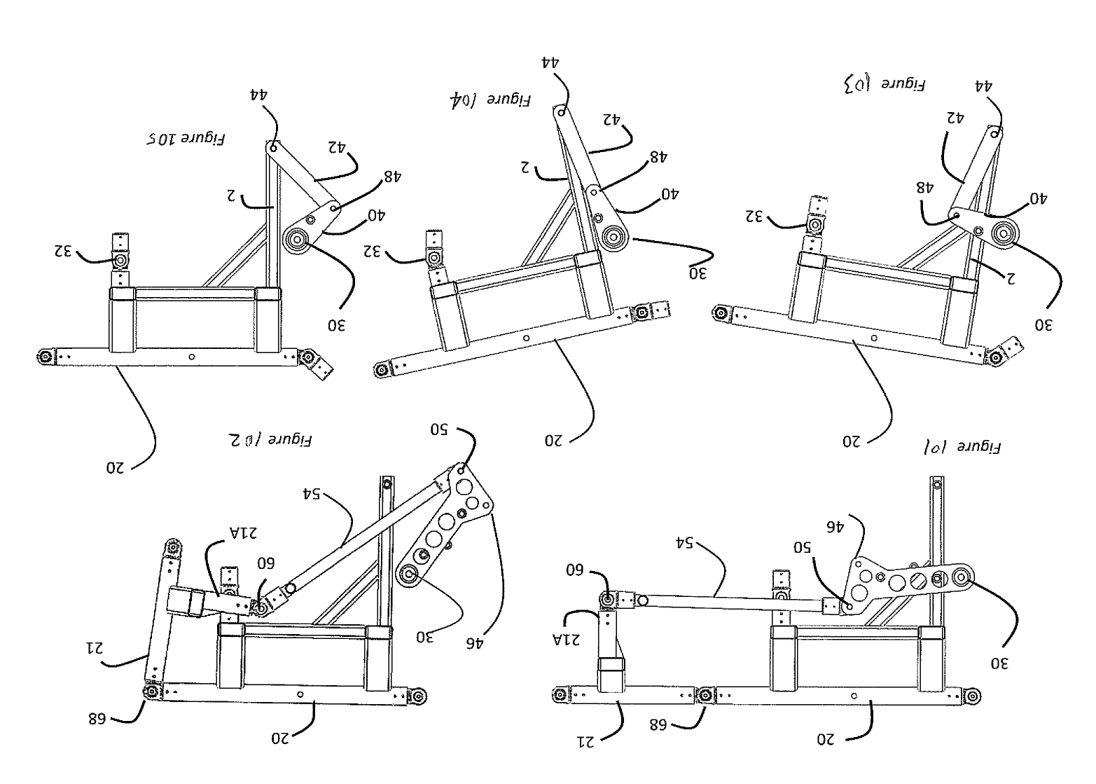

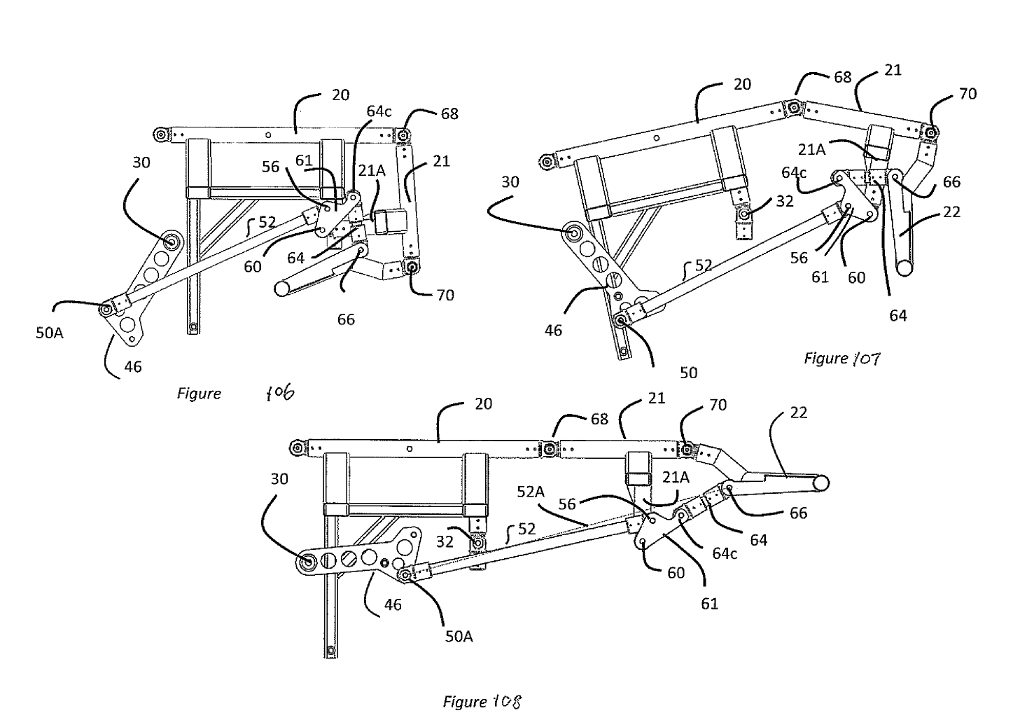

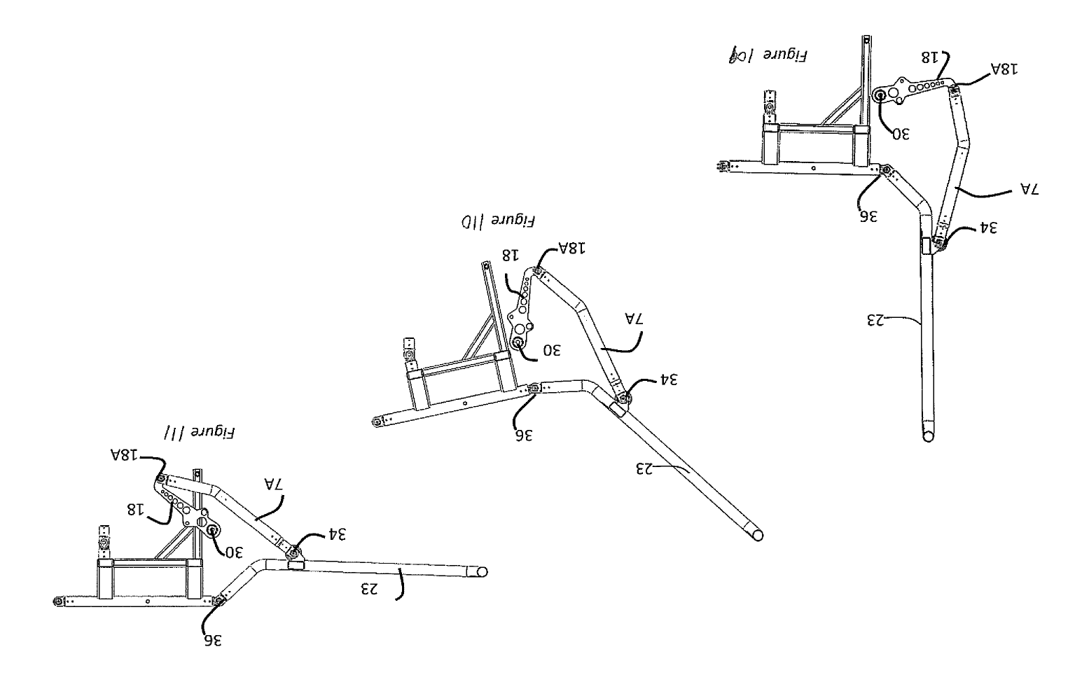

To assist the addressee with understanding articulation, an embodiment is shown in various stages of articulation with reference to FIGS. 97-99. FIGS. 100-111 are partial elevations of components during stages of articulation of the embodiment shown in FIGS. 97-99.

The use of axle 30 to perform articulation allows a single actuator to be used which has advantages or decreased cost and increased reliability. It will be seen from the foregoing description that the axle is located between the base and the mattress at a location along the longitudinal axis of the bedchair apparatus which is at or adjacent to the location of the hinge point between the seat section and the back rest section. This allows the axle to facilitate articulation of both the seat and back rest sections via levers connected to the axle.

The mattress may is some embodiments include a cavity for a flowable substance and means to introduce, expel or change the position or location of the flowable substance dependent on the articulation of the apparatus. This can increase comfort for a user who may have varying comfort or support requirements for various stages or attitudes of configuration of the apparatus in use. In one example, the flowable substance is a particulate substance such polystyrene foam beads the position of which may be moved dependent on articulation position. In another example the cavity comprises a bladder which can be filled (or evacuated, or have various divisions or chambers which can be controllably filled or evacuated) with a fluid (i.e. liquid or gas) that can be pumped to change the condition of the cavity as the articulation progresses.

Unless the context clearly requires otherwise, throughout the specification, the words “comprise”, “comprising”, and the like, are to be construed in an inclusive sense as opposed to an exclusive or exhaustive sense, that is to say, in the sense of “including, but not limited to”.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

1. A bed chair apparatus including a user support surface which includes a seat section a back section and a leg section, the back section being hingedly connected to one end of the seat section, and the leg section being hingedly connected to the other end of the seat section, whereby the user support surface is configurable in a bed configuration in which the support surface is substantially flat and in a chair configuration, the user support surface being supported on a frame, the frame including an axle and lever means dependent from the axle whereby the lever means control articulation of the user support surface between selected configurations upon rotation of the axle.

2. Apparatus as claimed in claim 1 including a single actuator means operable to cause rotation of the axle.

3. Apparatus as claimed in claim 1 wherein the support surface extends along a longitudinal axis of the apparatus and the axle extends transversely relative to the longitudinal axis.

4. Apparatus as claimed in claim 3 wherein the axle is provided between the frame and the support surface at a location along the longitudinal axis which is at or adjacent to the hinge connection between the seat section and the back section.

5. Apparatus as claimed in claim 1 wherein the seat section changes angle relative to the frame during articulation.

6. Apparatus as claimed in claim 1 wherein the support surface further includes a foot section hingedly connected to the leg section.

7. Apparatus as claimed in claim 6 wherein the foot section is linked to a rocker lever mounted beneath the leg section.

8. Apparatus as claimed in claim 7 wherein the rocker lever is pivotally connected to the leg section.

9. Apparatus as claimed in claim 8 wherein the rocker lever is linked to a drive lever dependent from the axle.

10. Apparatus as claimed in claim 9 wherein when the apparatus is in a bed configuration a connection between the drive lever and the link is in an over centre position.

11. Apparatus as claimed in claim 10 wherein a part of the drive lever bears against a part of the frame when in the over centre position.

12. Apparatus as claimed in claim 1 wherein a further axle is provided which is rotatable relative to the axle to further articulate the apparatus.

13. Apparatus as claimed in claim 1 wherein the frame is modular and is adapted to be individually selectively mounted on one of a plurality of different bases.

14. Apparatus as claimed in claim 2 wherein the actuator is mounted on or includes a shock absorber.

15. Apparatus as claimed in claim 1 wherein when in a bed configuration the hinged connections between the sections of the support surface are substantially aligned and located nearer to an upper surface of the mattress than a lower surface.
